(19) United States
(12) Patent Application Publication
(10) Pub. No.: US 2009/0226145 A1
(43) Pub. Date: Sep. 10, 2009

(54) Data processing device, data processing method, and program

(75) Inventors: Kazutaka Ando, Kanagawa (JP); Tetsujiro Kondo, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/380,746

(22) Filed: Mar. 3, 2009

(30) Foreign Application Priority Data
Mar. 5, 2008 (JP) P2008-054563
Nov. 13, 2008 (JP) P2008-291145

(51) Int. Cl. H04N 5/93

(52) U.S. Cl. 386/52

(57) ABSTRACT

A data processing device includes: a content receiving unit configured to receive a plurality of contents; a control data receiving unit configured to receive control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and an editing unit configured to generate the edited content, by editing the plurality of contents in accordance with the process parameter and the timing parameter included in the control data.

### CROSS REFERENCES TO RELATED APPLICATIONS

The present invention contains subject matter related to Japanese Patent Application JP 2008-291145 filed in the Japanese Patent Office on Nov. 13, 2008, the entire contents of which are incorporated herein by reference.

### BACKGROUND OF THE INVENTION

1. Field of the Invention

The present invention relates to a data processing device, a data processing method, and a program. More specifically, the present invention relates to a data processing device, a data processing method, and a program which make it possible to enhance the degree of freedom of editing.

2. Description of the Related Art

For example, in the case of television broadcasting in the related art, in a broadcasting station, content including images and sound as a so-called material (hereinafter, also referred to as material content) is edited, and content obtained as a result of the editing (hereinafter, also referred to as edited content) is broadcast as a program.

Therefore, on the receiving side of television broadcasting, the edited content is viewed as a program.

That is, on the receiving side, a user is not able to view, for example, scenes omitted during editing, or scenes seen from angles different from that of an image included in the edited content.

Also, on the receiving side, when a user is to perform editing of content, the editing is performed with respect to edited content. Therefore, although the user can perform such editing as to omit scenes that are not necessary for the user from the edited content, again, it is not possible for the user to perform such editing as to insert scenes omitted during editing in a broadcasting station.

On the other hand, in the case of broadcasting called multi-view broadcasting, a multi-view automatic switching table describing information on a plurality of switching patterns for images and sound is sent out from a broadcasting station. Then, on the receiving side, images and sound are switched by using the multi-view automatic switching table, thereby making it possible to switch images and sound in accordance with a switching pattern of the user's choice (see, for example, Japanese Unexamined Patent Application Publication No. 2002-314960).

### SUMMARY OF THE INVENTION

In the related art, the degree of freedom of editing that can be performed on the receiving side is not very high.

That is, in the related art, it is difficult to perform a process such as image quality adjustment for each one of the plurality of material contents.

It is thus desirable to enhance the degree of freedom of editing, thereby making it possible to, for example, provide content that is appropriate for the user.

A data processing device or a program according to an embodiment of the present invention is a data processing device that processes content, including: content receiving means for receiving a plurality of contents; control data receiving means for receiving control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and editing means for generating the edited content, by editing the plurality of contents in accordance with the process parameter and the timing parameter included in the control data, or a program for causing a computer to function as the data processing device.

A data processing method according to an embodiment of the present invention is a data processing method for a data processing device that processes content, including the steps of: receiving a plurality of contents, and receiving control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and generating the edited content, by editing the plurality of contents in accordance with the process parameter and the timing parameter included in the control data.

According to the embodiment as described above, a plurality of contents are received, and also control data is received. The control data includes a process parameter set for each of the plurality of contents to process each of the contents, and a timing parameter indicating an output timing at which each of the contents is outputted as edited content that is content that has undergone editing, and the control data is used for editing the plurality of contents to generate the edited content. Then, the edited content is generated by editing the plurality of contents in accordance with the process parameter and the timing parameter included in the control data.

A data processing device or a program according to an embodiment of the present invention is a data processing device that performs a process of editing a plurality of contents, including: generating means for generating a process parameter set for each of the plurality of contents to process each of the contents, and a timing parameter indicating an output timing at which each of the contents is outputted as edited content that is content that has undergone editing; editing means for generating the edited content, by editing the plurality of contents in accordance with the process parameter and the timing parameter; and output means for outputting control data that includes the process parameter and the timing parameter, and is used for editing the plurality of contents to generate the edited content, or a program for causing a computer to function as the data processing device.

A data processing method according to an embodiment of the present invention is a data processing method for a data processing device that performs a process of editing a plurality of contents, including the steps of: generating a process parameter set for each of the plurality of contents to process each of the contents, and a timing parameter indicating an output timing at which each of the contents is outputted as edited content that is content that has undergone editing; generating the edited content, by editing the plurality of contents in accordance with the process parameter and the timing parameter; and outputting control data that includes the process parameter and the timing parameter, and is used for editing the plurality of contents to generate the edited content.

According to the embodiment of the present invention as described above, a process parameter set for each of the plurality of contents to process each of the contents, and a timing parameter indicating an output timing at which each of the contents is outputted as edited content that is content that has undergone editing, are generated. Then, the edited content is generated by editing the plurality of contents in accordance with the process parameter and the timing parameter. On the other hand, control data, which includes the process parameter and the timing parameter and is used for editing the plurality of contents to generate the edited content, is outputted.

It should be noted that the data processing device may be an independent device, or may be internal blocks that constitute a single device.

Also, the program can be provided by being transmitted via a transmission medium, or by being recorded onto a recording medium.

According to the above-mentioned embodiments, the degree of freedom of editing can be enhanced.

### BRIEF DESCRIPTION OF THE DRAWINGS

FIG. 1 is a diagram showing a configuration example of a broadcasting system to which an embodiment of the present invention is applied;

FIG. 2 is a block diagram showing a configuration example of a setting unit and an editing unit;

FIG. 3 is a diagram showing an extraction window and a material image;

FIGS. 4A to 4B are diagrams illustrating processing in a zoom processing unit;

FIG. 5 is a block diagram showing a configuration example of a conversion device;

FIG. 6 is a flowchart illustrating processing in a setting unit and an editing unit;

FIG. 7 is a flowchart illustrating processing in a setting unit and an editing unit;

FIG. 8 is a block diagram showing a configuration example of a playback unit;

FIG. 9 is a flowchart illustrating processing in a playback unit; and

FIG. 10 is a block diagram showing a configuration example of a computer to which an embodiment of the present invention is applied.

### DESCRIPTION OF THE PREFERRED EMBODIMENTS

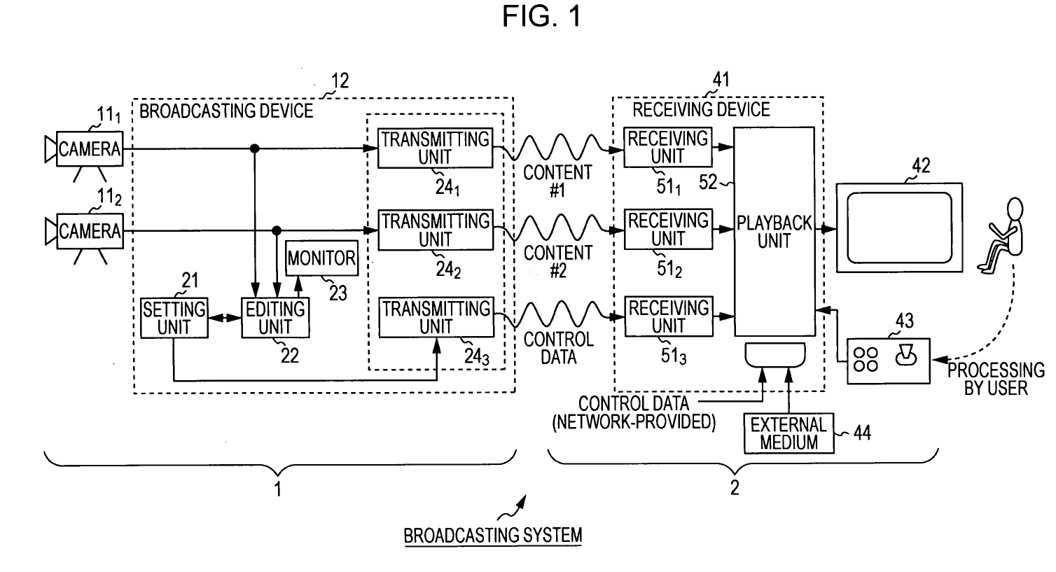

FIG. 1 shows a configuration example of a broadcasting system to which an embodiment of the present invention is applied.

In FIG. 1, a broadcasting system includes a transmitting-side device 1 and a receiving-side device 2.

There may be provided a plurality of transmitting-side devices 1. The same applies to the receiving-side device 2.

The transmitting-side device 1 is, for example, a device on the broadcasting station side, and includes a plurality of, for example, two cameras 11₁ and 11₂, and a broadcasting device 12.

The cameras 11₁ and 11₂ are fixed in place with a tripod or the like, for example. The cameras 11₁ and 11₂ shoot a sports match such as soccer or baseball, a singer's concert, an event in which cameras (multipoint cameras) are installed at multiple locations, or the like, and supplies an image and sound obtained as a result to the broadcasting device 12 as a material content that serves as a material.

In this regard, the cameras 11₁ and 11₂ are installed at different positions, and shoot images from different angles.

Further, the cameras 11₁ and 11₂ are high-resolution cameras with a large number of pixels, and shoot wide-angle images.

It is not always necessary to fix the cameras 11₁ and 11₂ in place with a tripod or the like.

Also, it is possible to provide not only the two cameras 11₁ and 11₂ but also three or more cameras.

The broadcasting device 12 includes a setting unit 21, an editing unit 22, a monitor 23, transmitting units 24₁, 24₂, and 24₃, and the like, and is a data processing device that performs processing such as editing two material contents as a plurality of contents from the cameras 11₁ and 11₂.

The setting unit 21 generates a process parameter and a timing parameter in response to an editing operation made by a content producer (user) or the like as the producer of a program to instruct editing, and supplies the process parameter and the timing parameter to the editing unit 22.

Also, the setting unit 21 outputs control data used for generating edited content, which is content that has undergone editing, by editing two material contents as a plurality of contents, including a material content #1 obtained with the camera 11₁, and a material content #2 obtained with the camera 11₂.

The control data outputted by the setting unit 21 is supplied to the transmitting unit 24₃.

In this regard, a process parameter is a parameter for processing material content, and is generated for each material content. In this example, as material contents, there are two material contents, the material content #1 obtained with the camera 11₁, and the material content #2 obtained with the camera 11₂, so the process parameter is generated for each of the two material contents #1 and #2.

Also, a timing parameter is a parameter indicating the output timing at which material content is outputted as edited content, and corresponds to, for example, a so-called editing point (IN point and OUT point).

It should be noted that, for example, cases in which the material content #1 is outputted as edited content include a case in which the edited content is switched to the material content #1 from the other material content #2, and a case in which the material content #1 is synthesized into the other material content #2 to be outputted as the edited content.

The editing unit 22 edits the two material contents #1 and #2 as a plurality of contents respectively supplied from the cameras 11₁ and 11₂, in accordance with the process parameter and the timing parameter supplied from the setting unit 21, thus generating and outputting edited content.

The edited content outputted by the editing unit 22 is supplied to the monitor 23.

The monitor 23 is configured by a display, a speaker, or the like, and presents the edited content from the editing unit 22. That is, the monitor 23 displays images (including letters) included in the edited content, and also outputs sound included in the edited content.

The transmitting unit 24₁ applies modulation and other necessary processing to the material content #1 supplied to the broadcasting device 12 from the camera 11₁, and transmits the resulting material content #1. The transmitting unit 24₂ applies modulation and other necessary processing to the material content #2 supplied to the broadcasting device 12 from the camera 11₂, and transmits the resulting material content #2.

The transmitting unit 24₃ applies modulation and other necessary processing to the control data supplied from the setting unit 21, and transmits the resulting control data.

Therefore, in the broadcasting device 12, edited content itself is not transmitted as a program. Instead of the edited content, the material contents #1 and #2 with respect to which editing for generating the edited content has been performed, and control data including a process parameter and a timing parameter with respect to each of the material contents #1 and #2 are transmitted.

In this regard, the edited content presented by the monitor 23 can be generated by editing, in accordance with the process parameter and the timing parameter included in the control data transmitted by the broadcasting device 12, the two material contents #1 and #2 transmitted by the broadcasting device 12.

This edited content presented by the monitor 23 is content which is obtained by editing according to an editing operation made by the content producer and on which the intention of the content producer is reflected. Hereinafter, the edited content is also referred to as standard content.

Also, control data including the process parameter and the timing parameter used in the editing for generating this standard content is also referred to as standard control data.

The material contents #1 and #2, and the standard control data which are transmitted from the broadcasting device 12 are received and processed by the receiving-side device 2.

That is, the receiving-side device 2 includes a receiving device 41, a monitor 42, a user I/F (Interface) 43, and the like.

The receiving device 41 includes receiving units 51₁, 51₂, and 51₃, and a playback unit 52, and is a data processing device that receives and processes the material contents #1 and #2, and the standard control data from the broadcasting device 12.

That is, the receiving unit 51₁ receives the material content #1 from the broadcasting device 12, applies modulation and other necessary processing, and supplies the resulting material content #1 to the playback unit 52. The receiving unit 51₂ receives the material content #2 from the broadcasting device 12, applies modulation and other necessary processing, and supplies the resulting material content #2 to the playback unit 52.

The receiving unit 51₃ receives the standard control data from the broadcasting device 12, applies modulation and other necessary processing, and supplies the resulting standard control data to the playback unit 52.

In addition, data (signal) is supplied to the playback unit 52 from the user I/F 43, an external medium 44, or a network (not shown), as necessary.

That is, the user I/F 43 is, for example, a button or the like (not shown) provided to a remote commander, or the casing of the receiving device 41. When operated by the user, the user I/F 43 supplies (transmits) an operation signal responsive to the operation to the playback unit 52.

The external medium 44 is, for example, an external removable medium such as a memory card, and can be mounted on and removed from the playback unit 52. Control data or the like can be recorded (stored) on the external medium 44. When the external medium 44 is mounted, the playback unit 52 reads and receives the control data recorded on the external medium 44 as necessary.

The playback unit 52 is capable of performing communication via the Internet or other such network. As necessary, the playback unit 52 downloads and receives control data from a server on the network.

The playback unit 52 edits the material content #1 from the receiving unit 51₁, and the material content #2 from the receiving unit 51₂ in accordance with, for example, process data and a timing parameter included in standard control data from the receiving unit 51₃, thereby generating edited content (standard content).

Also, the playback unit 52 edits the material content #1 from the receiving unit 51₁, and the material content #2 from the receiving unit 51₂ in accordance with, for example, process data and a timing parameter included in control data received from the external medium 44 or a network, thereby generating edited content.

Further, the playback unit 52 edits the material content #1 from the receiving unit 51₁, and the material content #2 from the receiving unit 51₂ in accordance with, for example, process data and a timing parameter generated in response to an operation signal from the user I/F 43, thereby generating edited content.

In this regard, in a case where editing is performed in the playback unit 52 in accordance with a process parameter and a timing parameter that are included in standard control data, standard content is generated as edited content.

On the other hand, in a case where editing is performed in the playback unit 52 in accordance with processing data and a timing parameter included in control data received from the external medium 44 or a network, or processing data and a timing parameter generated in response to an operation signal from the user I/F 43, standard content is not necessarily generated as edited content.

The edited content generated by the playback unit 52 is supplied to the monitor 42 and presented.

That is, the monitor 42 is configured by a display, a speaker, or the like, and displays an image included in the edited content from the playback unit 52 and also outputs sound included in the edited content.

In this regard, examples of content include image content, sound content, an image, and content including sound accompanying the image. In the following, for the simplicity of description, the description will focus on image content (content including at least an image).

It should be noted that the broadcasting system in FIG. 1 is applicable to any one of image content, sound content, content including an image and sound, and the like.

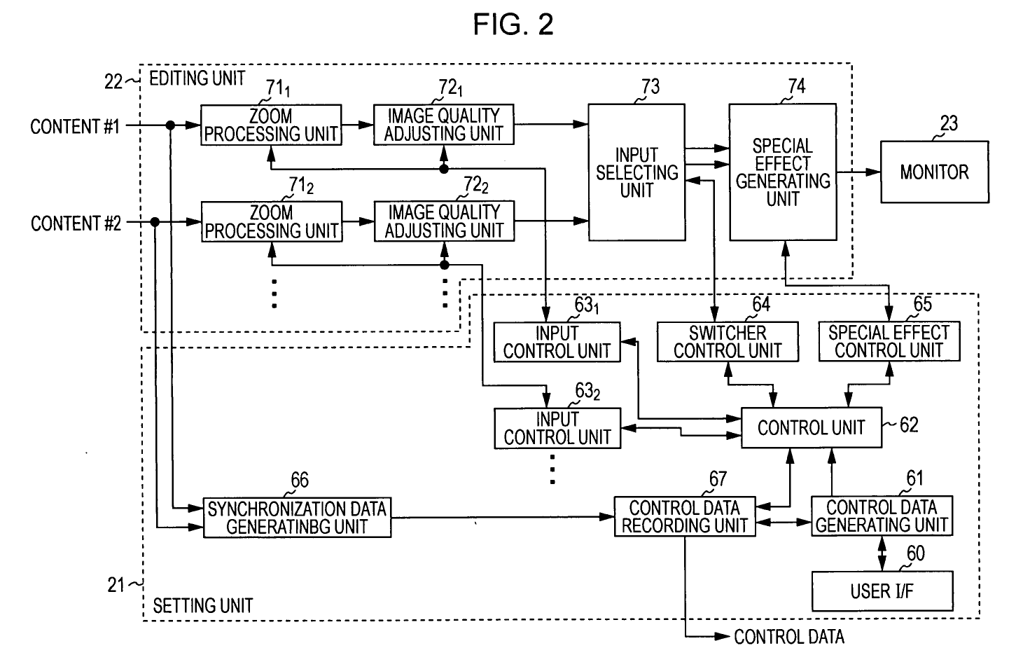

FIG. 2 shows a configuration example of the setting unit 21 and the editing unit 22 in FIG. 1.

In FIG. 2, the setting unit 21 includes a user I/F 60, a control data generating unit 61, a control unit 62, input control units 63₁ and 63₂, a switcher control unit 64, a special effect control unit 65, a synchronization data generating unit 66, a control data recording unit 67, and the like. The setting unit 21 generates a process parameter and a timing parameter in response to an operation made by a content producer or the like who is the user of the transmitting-side device 1.

That is, the user I/F 60 is an operation panel or the like for performing an editing operation. When operated by the content producer or the like as the user, the user I/F 60 supplies an operation signal responsive to the operation to the control data generating unit 61.

In response to the operation signal from the user I/F 60, the control data generating unit 61 generates a process parameter with respect to each of the material contents #1 and #2, and also generates a timing parameter. Further, the control data generating unit 61 generates control data (standard control data) including the process parameter and the timing parameter.

Then, the control data generating unit 61 supplies the process parameter and the timing parameter to the control unit 62, and supplies the control data to the control data recording unit 67.

In this regard, as described above, the control data generating unit 61 generates a process parameter with respect to each of the material contents #1 and #2 in response to an operation signal from the user I/F 60. Therefore, in a case where, for example, the content producer makes an editing operation for instructing different processes to be applied to the material contents #1 and #2, in the control data generating unit 61, different process parameters are generated with respect to the material contents #1 and #2 in response to the editing operation.

The control unit 62 controls individual units that constitute the setting unit 21.

That is, the control unit 62 controls the input control units 63₁ and 63₂, the switcher control unit 64, or the special effect control unit 65, in accordance with the process parameter and the timing parameter from the control data generating unit 61.

The control unit 62 controls the control data generating unit 61 or the control data recording unit 67, for example.

The input control unit 63₁ controls a zoom processing unit 71₁ and an image quality adjusting unit 72₁ that constitute the editing unit 22, in accordance with control by the control unit 62.

The input control unit 63₂ controls a zoom processing unit 71₂ and an image quality adjusting unit 72₂ that constitute the editing unit 22, in accordance with control by the control unit 62.

The switcher control unit 64 controls an input selecting unit 73 that constitutes the editing unit 22, in accordance with control by the control unit 62.

The special effect control unit 65 controls a special effect generating unit 74 that constitutes the editing unit 22, in accordance with control by the control unit 62.

The synchronization data generating unit 66 generates synchronization data, and supplies the synchronization data to the control data recording unit 67.

That is, the image of the material content #1 supplied to the editing unit 22 from the camera 11₁, and the image of the material content #2 supplied to the editing unit 22 from the camera 11₂ are supplied to the synchronization data generating unit 66.

The synchronization data generating unit 66 generates, as synchronization data, information that identifies each frame (or field) of the image of the material content #1, and supplies the synchronization data for each frame to the control data recording unit 67.

The synchronization data generating unit 66 generates synchronization data also with respect to the image of the material content #2, and supplies the synchronization data to the control data recording unit 67.

In this regard, as synchronization data that identifies each frame of an image, for example, a time code attached to the image can be adopted.

Also, as synchronization data for each frame, a feature value of the frame, a sequence of the respective feature values of several successive frames including the frame, or the like can be adopted.

As a feature value of a frame, it is possible to adopt, for example, an addition value of pixel values in a specific area (including the entire area) of the frame, several lower bits of the addition value, or the like as described in Japanese Patent Application Publication No. 2007-243259 or Japanese Patent Application Publication No. 2007-235374.

The control data recording unit 67 records (stores) the control data supplied from the control data generating unit 61 in association with the synchronization data supplied from the synchronization data generating unit 66.

That is, the control data recording unit 67 associates a process parameter for the image of a material content #i (here, i=1, 2), which is included in the control data supplied from the control data generating unit 61, with the synchronization data of a frame of the material content #i to which a process is applied in accordance with the process parameter.

The control data recording unit 67 outputs the control data (standard control data) associated with the synchronization data, to the transmitting unit 24₃ (FIG. 1) as appropriate.

The editing unit 22 includes zoom processing units 71₁, and 71₂, image quality adjusting units 72₁, and 72₂, an input selecting unit 73, a special effect generating unit 74, and the like. The editing unit 22 generates the image of edited content (standard content) by editing the images of the material contents #1 and #2 supplied from the cameras 11₁ and 11₂, in accordance with process parameters and timing parameters generated by the control data generating unit 61, and outputs the image to the monitor 23.

That is, the image of the material content #i supplied to the editing unit 22 from a camera 11ᵢ is supplied to a zoom processing unit 71ᵢ.

The zoom processing unit 71ᵢ performs a process of extracting an area to be outputted as the image of edited content, from the image of the material content #i from the camera 11ᵢ, in accordance with control by an input control unit 63ᵢ.

The zoom processing unit 71ᵢ supplies the image of the area extracted from the image of the material content #i from the camera 11ᵢ, to an image quality adjusting unit 72ᵢ.

In this regard, it should be noted that the zoom processing unit 71ᵢ performs, for example, a process (resizing) of changing the size of the image of the area extracted from the image of the material content #i from the camera 11ᵢ as necessary, thereby converting the image of the area extracted from the image of the material content #i from the camera 11ᵢ, into an image of a size (number of pixels) that matches the image of edited content.

The details of the process of extracting an area to be outputted as the image of edited content, from the image of the material content #i from the camera 11ᵢ, which is performed by the zoom processing unit 71ᵢ, will be given later.

The image quality adjusting unit 72ᵢ performs a process of adjusting the image quality of the image of the material content #i from the zoom processing unit 71ᵢ, in accordance with control by the input control unit 63ᵢ.

For example, the image quality adjusting unit 72ᵢ performs a noise removal process. That is, the image quality adjusting unit 72ᵢ converts the image of the material content #i from the zoom processing unit 71i into an image with reduced noise.

Also, the image quality adjusting unit 72ᵢ performs, for example, the process of improving the resolution of the image of the material content #i from the zoom processing unit 71ᵢ. That is, the image quality adjusting unit 72ᵢ converts the image of the material content #i from the zoom processing unit 71ᵢ into an image with higher resolution.

Further, the image quality adjusting unit 72ᵢ performs, for example, the process of enhancing the edges of the image of the material content #i from the zoom processing unit 71ᵢ. That is, the image quality adjusting unit 72ᵢ converts the image of the material content #i from the zoom processing unit 71ᵢ into an image with enhanced edges.

Also, the image quality adjusting unit 72ᵢ performs, for example, the process of improving the contrast of the image of the material content #i from the zoom processing unit 71ᵢ. That is, the image quality adjusting unit 72ᵢ converts the image of the material content #i from the zoom processing unit 71ᵢ into an image with higher contrast.

It should be noted that the kind of process applied to the image of the material content #i in the zoom processing unit 71ᵢ and the image quality adjusting unit 72ᵢ is determined by a process parameter with respect to the material content #i which is supplied from the control data generating unit 61 to the control unit 62.

The image of the material content #i obtained by the process in the image quality adjusting unit 72ᵢ is supplied to the input selecting unit 73.

The input selecting unit 73 selects an image(s) to be outputted as the image of edited content, from among the image of the material content #1 from the image quality adjusting unit 72₁, and the image of the material content #2 from the image quality adjusting unit 72₂, in accordance with control by the switcher control unit 64, and supplies the selected image to the special effect generating unit 74.

In this regard, the image to be selected by the input selecting unit 73 is determined by the timing parameter supplied from the control data generating unit 61 to the control unit 62.

That is, for example, in a case where the timing parameter indicates that one of the material contents #1 and #2 is to be set as the image of edited content, one of their images is selected in the input selecting unit 73.

It should be noted that in a case where one of the images of the material contents #1 and #2 is to be synthesized into the image of the other and set as edited content, both the images of the material contents #1 and #2 are selected in the input selecting unit 73.

The special effect generating unit 74 performs a process of adding a special effect to one or more images supplied from the input selecting unit 73, in accordance with control by the special effect control unit 65, and outputs the image obtained as a result as the image of edited content (standard content).

That is, when switching the image of edited content from one of the images of the material contents #1 and #2 to the image of the other, for example, the special effect generating unit 74 adds the special effect of fading out from one image while fading into the other image.

It should be noted that in the special effect generating unit 74, synthesizing the image of the other into one of the images of the material contents #1 and #2 is also performed as a special effect.

Also, in the special effect generating unit 74, synthesizing a telop into one of the images of the material contents #1 and #2 or an image obtained by synthesizing one of the images into the other, is also performed as a special effect.

In this regard, the kind of process in the special effect generating unit 74, that is, the kind of special effect added to an image is determined by a process parameter with respect to the material content #i, which is supplied to the control unit 62 from the control data generating unit 61.

The image of edited content (standard content) outputted by the special effect generating unit 74 is supplied to the monitor 23 and displayed.

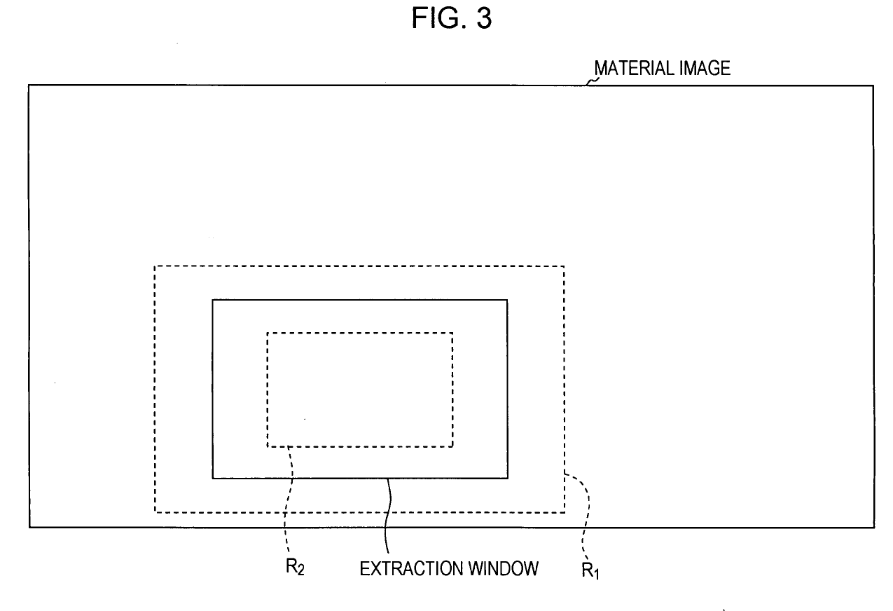

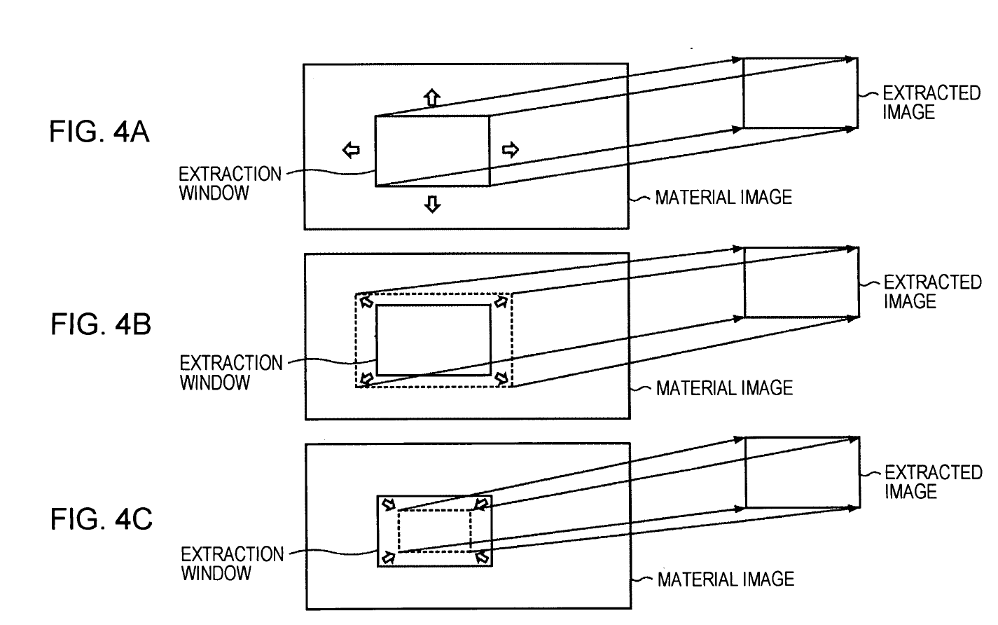

Next, referring to FIGS. 3 and 4, a description will be given of the process of extracting an area to be outputted as the image of edited content, from the image of the material content #i from the camera 11ᵢ, which is performed by the zoom processing unit 71ᵢ in FIG. 2.

The zoom processing unit 71ᵢ extracts an area to be outputted as the image of edited content, from the image of the material content #i from the camera 11ᵢ, thereby enabling an editing operation that vicariously realizes a panning, tilting, or zooming operation of a virtual camera that shoots the image of that area.

That is, supposing, now, that a virtual camera is shooting a part of a scene appearing in the image of the material content #i from the camera 11ᵢ, the virtual camera can perform a panning or tilting operation within the range of the scene appearing in the image of the material content #i.

Further, the virtual camera can perform a zooming (zooming-in and zooming-out) operation within the range of the scene appearing in the image of the material content #i.

In this regard, the operation of panning the virtual camera is also referred to as pseudo-panning operation, and the operation of tilting the virtual camera is also referred to as pseudo-tilting operation. In addition, the zooming operation of the virtual camera is also referred to as pseudo-zooming operation (pseudo-zooming-in operation and pseudo-zooming-out operation).

As an editing operation on the user I/F 60 in FIG. 2, the pseudo-panning operation, the pseudo-tilting operation, and the pseudo-zooming operation described above can be performed.

In cases where, for example, a pseudo-panning operation, a pseudo-tilting operation, or a pseudo-zooming operation is performed as an editing operation on the user I/F 60, in the control data generating unit 61, information indicating the area to be outputted as the image of edited content, from the image of the material content #i from the camera 11ᵢ, is generated as a process parameter in response to the editing operation.

In this regard, the area to be outputted as the image of edited content from the image of the material content #i is also referred to as extraction window.

Also, the image of the material content #i is also referred to as material image #i, and the image of edited content is also referred to as edited image.

FIG. 3 shows the extraction window and the material image #i.

For example, supposing, now, that a virtual camera is shooting a rectangular area of the material image #i which is enclosed by the solid line in FIG. 3, the extraction window matches the rectangular area.

If, for example, a pseudo-zooming operation is performed thereafter, the angle of view of the image shot by the virtual camera becomes wider, and thus the extraction window becomes a large-sized area as indicated by R₁ in FIG. 3.

Also, if, for example, a pseudo-zooming-in operation is performed, the angle of view of the image shot by the virtual camera becomes narrower, and thus the extraction window becomes a small-sized area as indicated by R₂ in FIG. 3.

In this regard, while the zoom processing unit 71ᵢ in FIG. 2 extracts an image within an extraction window from the image of the material content #i from the camera 11ᵢ, hereinafter, an image within an extraction window which is extracted from the image of the material content #i is also referred to as extracted image.

As described above, since the size of the extraction window is not necessarily constant, the size (number of pixels) of an extracted image is not necessarily constant, either.

When an extracted image whose size is not constant is set as the image of edited content, the size of the image of edited content does not become constant, either.

Accordingly, in order to make the size of the image of edited content be a predetermined constant size, as described above, the zoom processing unit 71ᵢ performs a process of changing the size of the image of an area extracted from the image of the material content #i from the camera 11ᵢ, thereby converting an extracted image extracted from the image of the material content #i from the camera 11ᵢ, into an image of a predetermined constant size (for example, a size determined in advance as the size of the image of edited content).

In this regard, while examples of a conversion process of converting an image of a given size into an image of another size include a simple thinning-out or interpolation of pixels, there is also DRC (Digital Reality Creation) previously proposed by the present applicant. The DRC will be described later.

Referring to FIGS. 4A to 4C, a further description will be given of processing in the zoom processing unit 71ᵢ in FIG. 2.

In a case where a pseudo-panning operation or a pseudo-tilting operation is performed as an editing operation on the user I/F 60 (FIG. 2), the control data generating unit 61 generates a process parameter indicating the position of an extraction window after the extraction window is moved on the image of the material content #i from the camera 11ᵢ horizontally or vertically from the current position by an amount of movement according to the pseudo-panning operation or the pseudo-tilting operation as shown in FIG. 4A, and the current size of the extraction window.

Further, in this case, in the zoom processing unit 71ᵢ, an image within an extraction window that has been moved is extracted as an extracted image from the image of the material content #i, and the extracted image is converted into an image of a predetermined constant size (enlarged or reduced).

Also, in a case where a pseudo-zooming-out operation is performed as an editing operation on the user I/F 60, the control data generating unit 61 generates process parameters indicating the size of an extraction window after the extracting window is changed from the current size to a size enlarged by a ratio according to the pseudo-zooming-out operation, on the image of the material content #i from the camera 11ᵢ as shown in FIG. 4B, and the current position of the extraction window.

Further, in this case, in the zoom processing unit 71ᵢ, an image within the extraction window whose size has been changed is extracted as an extracted image from the image of the material content #i, and the extracted image is converted into an image of a predetermined constant size.

Also, in a case where a pseudo-zooming-in operation is performed as an editing operation on the user I/F 60, the control data generating unit 61 generates a process parameter indicating the size of an extraction window after the extracting window is changed from the current size to a size reduced by a ratio according to the pseudo-zooming-in operation, on the image of the material content #i from the camera 11ᵢ as shown in FIG. 4C, and the current position of the extraction window.

Further, in this case, in the zoom processing unit 71ᵢ, an image within the extraction window whose size has been changed is extracted as an extracted image from the image of the material content #i, and the extracted image is converted into an image of a predetermined constant size.

Therefore, with the zoom processing unit 71ᵢ, it is possible to obtain an extracted image as if it were being actually shot with a camera, while performing a panning, tilting, or zooming operation.

It should be noted that a method of obtaining an extracted image in accordance with a pseudo-panning operation, a pseudo-tilting operation, or a pseudo-zooming operation as mentioned above is described in, for example, Japanese Patent No. 3968665.

In this regard, as described above, while the zoom processing unit 71ᵢ performs a conversion process of changing the size of an extracted image extracted from the image of the material content #i from the camera 11ᵢ, DRC can be used for the conversion process.

The DRC is a technique for converting (mapping) first data into second data different from the first data, in which tap coefficients that statistically minimize the prediction error of a predicted value of the second data obtained by a computation using the first data and predetermined tap coefficients (coefficients used for a computation using the first data) are obtained in advance for each of a plurality of classes, and the first data is converted into the second data (a predicted value of the second data is obtained) by a computation using the tap coefficients and the first data.

The DRC for converting the first data into the second data is implemented in various forms of signal processing depending on the definitions of the first data and second data.

That is, for example, provided that the first data is image data with a predetermined number of pixels, and the second data is image data whose number of pixels is increased or reduced from that of the first data, the DRC is a resizing process of resizing (changing the size of) an image.

The zoom processing unit 71ᵢ performs DRC as the resizing process, thus changing the size of an extracted image.

It should be noted that, alternatively, for example, provided that the first data is image data with low spatial resolution, and the second data is image data with high spatial resolution, the DRC is a spatial resolution creation (improving) process of improving the spatial resolution (a conversion process of converting an image into an image with higher spatial resolution than that image).

Also, for example, provided that the first data is image data with low S/N (Signal/Noise), and the second data is image data with high S/N, the DRC is a noise removal process of removing noise contained in an image (a conversion process of converting an image into an image with less noise than that image).

Further, for example, provided that the first data is image data with low temporal resolution (low frame rate), and the second data is image data with high temporal resolution (high frame rate), the DRC is a temporal resolution creation (improving) process of improving the temporal resolution (a conversion process of converting an image into an image with higher temporal resolution than that image).

Also, for example, provided that the first data is image data with low contrast, and the second data is image data with high contrast, the DRC is a process of improving the contrast (a conversion process of converting an image into an image with higher contrast than that image).

Further, for example, provided that the first data is image data with low level of edge enhancement, and the second data is image data with enhanced edges, the DRC is a process of enhancing edges (a conversion process of converting an image into an image with more enhanced edges than that image).

Further, for example, provided that the first data is sound data with low S/N, and the second data is sound data with high S/N, the DRC is a noise removal process of removing noise contained in sound (a conversion process of converting sound into sound with less noise than that sound).

Therefore, the DRC can be also used for the process of adjusting the image quality, such as converting the image of the material content #i from the zoom processing unit 71ᵢ into an image with reduced noise, in the image quality adjusting unit 72ᵢ.

In the DRC, (a predicted value of the sample value of) a target sample is obtained by a computation using tap coefficients of a class obtained by classifying (the sample value of) a target sample among a plurality of samples that constitute the second data into one of a plurality of classes, and (the sample values of) a plurality of samples of the first data selected with respect to the target sample.

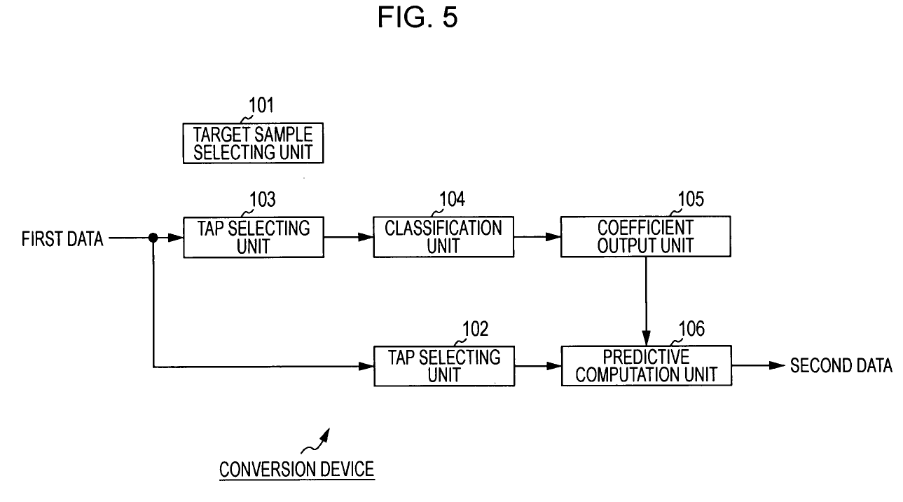

That is, FIG. 5 shows a configuration example of a conversion device that converts the first data into the second data by the DRC.

The first data is supplied to the conversion device, and the first data is supplied to tap selecting units 102 and 103.

A target sample selecting unit 101 sequentially sets, as a target sample, a sample that constitutes the second data that is to be obtained by converting the first data, and supplies information indicating the target sample to necessary blocks.

The tap selecting unit 102 selects, as a prediction tap, (the sample values of) several samples that constitute the first data which are used for predicting (the sample value) of the target sample.

Specifically, the tap selecting unit 102 selects, as a prediction tap, a plurality of samples of the first data located spatially or temporally close to the position of the target sample.

For example, if the first data and the second data are image data, (the pixel values of) a plurality of pixels of image data as the first data located spatially or temporally close to a pixel as the target sample are selected as a prediction tap.

Also, for example, if the first data and the second data are sound data, (the sample values of) a plurality of samples of sound data as the first data located spatially or temporally close to the target sample are selected as a prediction tap.

The tap selecting unit 103 selects, as a class tap, a plurality of samples that constitute the first data used for performing classification of classifying the target sample into one of a plurality of predetermined classes. That is, the tap selecting unit 103 selects a class tap in the same manner as that in which the tap selecting unit 102 selects a prediction tap.

It should be noted that a prediction tap and a class tap may have the same tap structure (the positional relationship between a plurality of samples as a prediction tap (class tap) with reference to a target sample), or may have different tap structures.

The prediction tap obtained in the tap selecting unit 102 is supplied to a predictive computation unit 106, and the class tap obtained in the tap selecting unit 103 is supplied to a classification unit 104.

The classification unit 104 performs a classification of clustering a target sample on the basis of the class tap from the tap selecting unit 103, and supplies a class code corresponding to the class of the target sample obtained as a result, to a coefficient output unit 105.

It should be noted that in the classification unit 104, for example, information including the level distribution of the sample values of a plurality of samples that constitute a class tap is set as the class (class code) of a target sample.

That is, in the classification unit 104, for example, a value obtained by sequentially arranging the sample values of samples that constitute a class tap is set as the class of a target sample.

In this case, provided that the class tap is constituted by the sample values of N samples, and M bits are assigned to the sample values of individual samples, the total number of classes is (2^{N})^{M}.

The total number of classes can be made less than (2^{N})^{M} as follows, for example.

That is, as a method of reducing the total number of classes, for example, there is a method of using ADRC (Adaptive Dynamic Range Coding).

In the method using ADRC, (the sample values of) samples that constitute a class tap are subjected to an ADRC process, and an ADRC code obtained as a result is determined to be the class of a target sample.

In K-bit ADRC, for example, the largest value MAX and smallest value MIN of sample values that constitute a class tap are detected, and with DR=MAX−MIN as the local dynamic range of a set, the sample values of individual samples that constitute the class tap are re-quantized into K (<M) bits on the basis of this dynamic range DR. That is, the smallest value MIN is subtracted from the sample values of individual samples that constitute the class tap, and the subtraction values are divided (re-quantized) by DR/2^{K}. Then, a bit string in which the sample values of individual samples of K bits that constitute the class tap and are obtained in this way are arranged in a predetermined order is outputted as an ADRC code. Therefore, in a case where a class tap is subjected to, for example, a 1-bit ADRC process, the sample values of individual samples that constitute the class tap are divided by the average value of the largest value MAX and the smallest value MIN (the fractional portion is dropped), and thus the sample values of individual samples are converted into a 1-bit form (binarized). Then, a bit string in which the 1-bit sample values are arranged in a predetermined order is outputted as an ADRC code.

In this regard, other methods for reducing the total number of classes include, for example, a method in which a class tap is regarded as a vector whose components are the sample values of individual samples that constitute the class tap, and a quantized value (code of a code vector) obtained by vector quantization of the vector is set as a class.

The coefficient output unit 105 stores tap coefficients for each class obtained by learning described later, and further outputs, from among the stored tap coefficients, tap coefficients stored at an address corresponding to the class code supplied from the classification section 104 (tap coefficients for a class indicated by the class code supplied from the classification unit 104). The tap coefficients are supplied to the predictive computation unit 106.

In this regard, a tap coefficient corresponds to a coefficient that is multiplied by input data in a so-called tap in a digital filter.

The predictive computation unit 106 acquires (a plurality of sample values as) a prediction tap outputted by the tap selecting unit 102, and tap coefficients outputted by the coefficient output unit 105, and performs a predetermined predictive computation for obtaining a predicted value of the true value of a target sample, by using the prediction tap and the tap coefficients. Thus, the predictive computation unit 106 obtains (a predicted value of) the sample value of the target sample, that is, the sample value of a sample that constitutes the second data, and outputs the sample value.

In the conversion device configured as described above, the target sample selecting unit 101 selects, as a target sample, one sample that has not been selected as a target sample, from among the samples that constitute the second data with respect to the first data inputted to the conversion device (the second data that is to be obtained by converting the first data).

On the other hand, the tap selecting units 102 and 103 select samples that serve as a prediction tap and a class tap for a target sample, from the first data inputted to the conversion device. The prediction tap is supplied from the tap selecting unit 102 to the predictive computation unit 106, and the class tap is supplied from the tap selecting unit 103 to the classification unit 104.

The classification unit 104 receives from the tap selecting unit 103 a class tap with respect to a target sample, and classifies the target sample on the basis of the class tap. Further, the classification unit 104 supplies a class code indicating the class of the target sample obtained as a result of the classification to the coefficient output unit 105.

The coefficient output unit 105 acquires tap coefficients stored at an address corresponding to the class code supplied from the classification unit 104, and supplies the tap coefficients to the predictive computation unit 106.

The predictive computation unit 106 performs a predetermined predictive computation by using the prediction tap supplied from the tap selecting unit 102, and the tap coefficients from the coefficient output unit 105. Thus, the predictive computation unit 106 obtains the sample value of a target sample and outputs the sample value.

Subsequently, in the target sample selecting unit 101, one sample that has not been selected as a target sample is selected as a target sample anew from among the samples that constitute the second data with respect to the first data inputted to the conversion device, and similar processing is repeated.

Next, a description will be given of a predictive computation in the predictive computation unit 106 in FIG. 5, and learning of tap coefficients stored in the coefficient output unit 105.

It should be noted that in this example, for example, image data is adopted as the first data and the second data.

Now, a case is considered in which, for example, supposing that image data (high-quality image data) of high image quality with a large number of pixels is the second data, and image data (low-quality image data) of low image quality with a number of pixels reduced from that of the high-quality image data is the first data, a prediction tap is selected from the low-quality image data as the first data, and the pixel values of pixels (high-quality pixels) of the high-quality image data as the second data are obtained (predicted) by a predetermined predictive computation by using the prediction tap and tap coefficients.

Assuming that as the predetermined predictive computation, for example, a linear first-order predictive computation is adopted, the pixel value y of a high-quality pixel is obtained by the following linear first-order equation.

$$\begin{matrix}[ Eq . 1 ] & \\ y = {\sum }_{n = 1}^{N} {w}_{n} {x}_{n} & ( 1 )\end{matrix}$$

It should be noted that in Equation (1), xₙ represents the pixel value of the n-th pixel of the low-quality image data (hereinafter, referred to as low-quality pixel as appropriate) that constitutes a prediction tap with respect to the high-quality pixel y, and wₙ represents the n-th tap coefficient that is multiplied by (the pixel value of) the n-th low-quality pixel. In Equation (1), it is assumed that the prediction tap is constituted by N low-quality pixels x₁, x₂, . . . , x_{N}.

In this regard, it is also possible to obtain the pixel value y of a high-quality pixel not by the linear first-order equation indicated by Equation (1) but by a second or higher order equation.

Now, let the true value of the pixel value of the k-th pixel that is a high-quality pixel be represented by yₖ, and a predicted value of the true value yₖ obtained by Equation (1) be yₖ′, a prediction error eₖ between the two values is represented by the following equation.

[Eq. 2]

eₖ=yₖ−yₖ′ (2)

Now, since the predicted value yₖ′ in Equation (2) is obtained in accordance with Equation (1), replacing yₖ′ in Equation (2) in accordance with Equation (1) gives the following equation.

$$\begin{matrix}[ Eq . 3 ] & \\ {e}_{k} = {y}_{k} - ( {\sum }_{n = 1}^{N} {w}_{n} {x}_{n , k} ) & ( 3 )\end{matrix}$$

It should be noted that in Equation (3), x_{n,k} represents the n-th low-quality pixel that constitutes an image prediction tap with respect to the k-th pixel that is a high-quality pixel.

While a tap coefficient wₙ that makes the prediction error eₖ in Equation (3) (or Equation (2)) become zero is optimal for predicting the high-quality pixel, it is generally difficult to obtain such a tap coefficient wₙ with respect to every high-quality pixel.

Accordingly, supposing that, for example, the least square method is adopted as a criterion (standard) indicating that a prediction coefficient wₙ is optimal, the optimal prediction coefficient wₙ can be obtained by minimizing the total sum E of square errors represented by the following equation.

$$\begin{matrix}[ Eq . 4 ] & \\ E = {\sum }_{k = 1}^{K} {e}_{k}^{2} & ( 4 )\end{matrix}$$

It should be noted that in Equation (4), K represents the number of pixels (the number of pixels for learning) of sets including the high-quality pixel yₖ, and low-quality pixels x_{1,k}, x_{2,k}, . . . , x_{N,k} that constitute a prediction tap with respect to the high-quality pixel yₖ.

As indicated by Equation (5), the smallest value (minimum value) of the total sum E of square errors in Equation (4) is given by wₙ that makes the result of partial differentiation of the total sum E with respect to the tap coefficient wₙ become zero.

$$\begin{matrix}[ Eq . 5 ] & \\ \frac{\partial E}{\partial {w}_{n}} = {e}_{1} \frac{\partial {e}_{1}}{\partial {w}_{n}} + {e}_{2} \frac{\partial {e}_{2}}{\partial {w}_{n}} + … + {e}_{k} \frac{\partial {e}_{k}}{\partial {w}_{n}} = 0 \\ ( n = 1 , 2 , … , N ) & ( 5 )\end{matrix}$$

Accordingly, by performing partial differentiation of Equation (3) with respect to the tap coefficient wₙ, the following equation is obtained.

$$\begin{matrix}[ Eq . 6 ] & \\ \frac{\partial {e}_{k}}{\partial {w}_{1}} = - {x}_{1 , k} , \frac{\partial {e}_{k}}{\partial {w}_{2}} = - {x}_{2 , k} , … , \frac{\partial {e}_{k}}{\partial {w}_{N}} = - {x}_{N , k} , \\ ( k = 1 , 2 , … , K ) & ( 6 )\end{matrix}$$

The following equation is obtained from Equation (5) and Equation (6).

$$\begin{matrix}[ Eq . 7 ] & \\ {\sum }_{k = 1}^{K} {e}_{k} {x}_{1 , k} = 0 , {\sum }_{k = 1}^{K} {e}_{k} {x}_{2 , k} = 0 , … {\sum }_{k = 1}^{K} {e}_{k} {x}_{N , k} = 0 & ( 7 )\end{matrix}$$

By substituting Equation (3) into eₖ in Equation (7), Equation (7) can be represented by a normal equation indicated in Equation (8).

$$\begin{matrix}[ Eq . 8 ] & \\ [ \begin{matrix}( {\sum }_{k = 1}^{K} {x}_{1 , k} {x}_{1 , k} ) & ( {\sum }_{k = 1}^{K} {x}_{1 , k} {x}_{2 , k} ) & … & ( {\sum }_{k = 1}^{K} {x}_{1 , k} {x}_{N , k} ) \\ ( {\sum }_{k = 1}^{K} {x}_{2 , k} {x}_{1 , k} ) & ( {\sum }_{k = 1}^{K} {x}_{2 , k} {x}_{2 , k} ) & … & ( {\sum }_{k = 1}^{K} {x}_{2 , k} {x}_{N , k} ) \\ ⋮ & ⋮ & ⋰ & ⋮ \\ ( {\sum }_{k = 1}^{K} {x}_{N , k} {x}_{1 , k} ) & ( {\sum }_{k = 1}^{K} {x}_{N , k} {x}_{2 , k} ) & … & ( {\sum }_{k = 1}^{K} {x}_{N , k} {x}_{N , k} )\end{matrix} ] [ \begin{matrix}{w}_{1} \\ {w}_{2} \\ ⋮ \\ {w}_{N}\end{matrix} ] = [ \begin{matrix}( {\sum }_{k = 1}^{K} {x}_{1 , k} {y}_{k} ) \\ ( {\sum }_{k = 1}^{K} {x}_{2 , k} {y}_{k} ) \\ ⋮ \\ ( {\sum }_{k = 1}^{K} {x}_{N , k} {y}_{k} )\end{matrix} ] & ( 8 )\end{matrix}$$

The normal equation of Equation (8) can be solved with respect to the tap coefficient wₙ by using, for example, the sweep out method (Gauss-Jordan elimination method).

By setting up and solving the normal equation of Equation (8) for each class, an optimal tap coefficient (in this case, a tap coefficient that minimizes the total sum E of square errors) wₙ can be obtained for each class.

Learning of tap coefficients is performed by preparing a large number of pieces of student data (in the above-described example, low-quality image data) corresponding to the first data, and teacher data (in the above-described example, high-quality image data) corresponding to the second data, and using the pieces of prepared student data and teacher data.

That is, in the learning of tap coefficients, a sample of teacher data is sequentially set as a target sample, and with respect to the target sample, a plurality of samples serving as a prediction tap, and a plurality of samples serving as a class tap are selected from the student data.

Further, classification of a target sample is performed by using a class tap, and the normal equation of Equation (8) is set up for each of the obtained class by using the target sample (yₖ) and the prediction tap (x_{1,k}, x_{2,k}, x_{N,k}).

Then, by solving the normal equation of Equation (8) for each class, tap coefficients for each class are obtained.

The tap coefficients for each class obtained by the above-mentioned learning of tap coefficients are stored in the coefficient output unit 105 in FIG. 5.

In this regard, depending on the way the student data corresponding to the first data and the teacher data corresponding to the second data are selected, as described above, as tap coefficients, it is possible to obtain tap coefficients for performing various kinds of signal processing.

That is, as described above, learning of tap coefficients is performed by using high-quality image data as teacher data corresponding to the second data and by using, as student data corresponding to the first data, low-quality image data whose number of pixels is reduced from that of the high-quality image data. Thus, as tap coefficients, it is possible to obtain tap coefficients for performing a resizing process of converting the first data as low-quality image data into the second data as high-quality image data whose number of pixels is improved (whose size is enlarged) can be obtained.

Also, for example, by performing learning of tap coefficients by using high-quality image data as teacher data and using, as student data, image data obtained by superimposing noise on the high-quality image data as the teacher data, it is possible to obtain, as tap coefficients, tap coefficients for performing a noise removable process of converting the first data that is image data with low S/N, into the second data with high S/N from which noise contained in the first data is removed (reduced).

Further, for example, by performing learning of tap coefficients by using sound data with high sampling rate as teacher data and using, as student data, sound data with low sampling rate obtained by thinning out the samples of the teacher image, it is possible to obtain, as tap coefficients, tap coefficients for performing a temporal resolution creating process of converting the first data that is sound data with low sampling rate, into the second data that is sound data with high sampling rate.

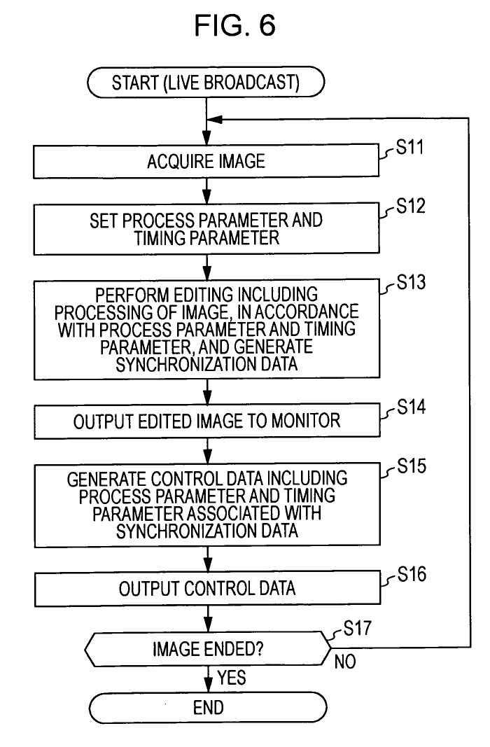

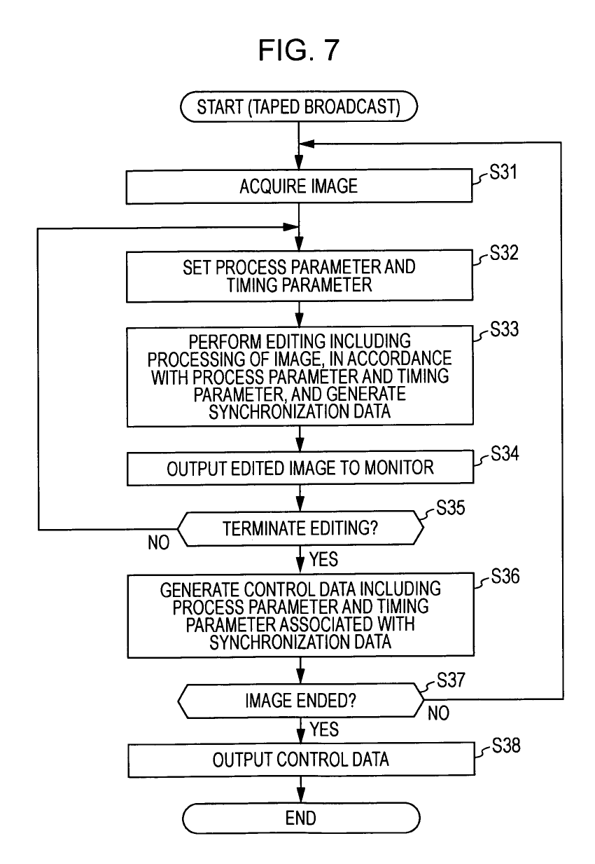

Next, referring to FIGS. 6 and 7, processing in the setting unit 21 and the editing unit 22 in FIG. 2 will be described.

FIG. 6 is a flowchart illustrating processing in the setting unit 21 and the editing unit 22 in a case where a so-called live broadcast is performed.

The zoom processing unit 71ᵢ waits for, for example, the image of one frame of material content #i to be supplied from the camera 11ᵢ to the editing unit 22, and in step S11, receives and acquires the image of one frame. The processing then proceeds to step S12.

In step S12, in response to an operation signal from the user I/F 60, the control data generating unit 61 generates a process parameter and a timing parameter with respect to each of the material contents #1 and #2, and supplies the generated parameters to the control unit 62.

Further, in step S12, the control unit 62 sets the process parameter and the timing parameter from the control data generating unit 61 to necessary blocks among the input control units 63₁, and 63₂, the switcher control unit 64, and the special effect control unit 65, and the processing proceeds to step S13.

In step S13, the zoom processing units 71₁, and 71₂, the image quality adjusting units 72₁ and 72₂, the input selecting unit 73, and the special effect generating unit 74 that constitute the editing unit 22 perform an editing process including image processing on the image acquired in step S11, in accordance with the process parameter and the timing parameter generated by the control data generating unit 61.

That is, in a case when a process parameter is set from the control unit 62, the input control unit 63ᵢ controls the zoom processing unit 71ᵢ and the image quality adjusting unit 72ᵢ in accordance with the process parameter.

Also, in a case when a timing parameter is set from the control unit 62, the switcher control unit 64 controls the input selecting unit 73 in accordance with the timing parameter.

Further, in a case when a process parameter is set from the control unit 62, the special effect control unit 65 controls the special effect generating unit 74 in accordance with the process parameter.

In accordance with control by the input control unit 63ᵢ, the zoom processing unit 71ᵢ extracts an extracted image to be outputted as the image of edited content, from the image of the material content #i from the camera 11ᵢ and further, as necessary, converts the extracted image into an image of a size that matches the image of edited content, and supplies the image to the image quality adjusting unit 72ᵢ.

In accordance with control by the input control unit 63ᵢ, the image quality adjusting unit 72ᵢ adjusts the image quality of the image (extracted image) of the material content #i from the zoom processing unit 71ᵢ, and supplies the image to the input selecting unit 73.

In accordance with control by the switcher control unit 64, the input selecting unit 73 selects an image to be outputted as the image of edited content, from among the image of the material content #1 from the image quality adjusting unit 72₁, and the image of the material content #2 from the image quality adjusting unit 72₂, and supplies the image to the special effect generating unit 74.

In accordance with control by the special effect control unit 65, the special effect generating unit 74 adds a special effect to one or more images supplied from the input selecting unit 73, and outputs the image obtained as a result to the monitor 23, as the image of edited content (standard content).

It should be noted that in a case where various conversion processes using the DRC described above are performed in the zoom processing unit 71ᵢ or the image quality adjusting unit 72ᵢ, tap coefficients used for performing the various conversion processes are stored. The tap coefficient to be used by the zoom processing unit 71ᵢ or the image quality adjusting unit 72ᵢ is specified by the process parameter.

In step S13, the above-described editing process is performed, and also synchronization data is generated.

That is, the image of one frame of the material content #i supplied to the editing unit 22 from the camera 11ᵢ is also supplied to the synchronization data generating unit 66.

The synchronization data generating unit 66 generates synchronization data of the image of one frame of the material content #i supplied to the synchronization data generating unit 66, and supplies the synchronization data to the control data recording unit 67. Then, the processing proceeds from step S13 to step S14.

In this regard, in a case where the content producer has not performed an editing operation on the user I/F 60, the control data generating unit 61 generates a process parameter and a timing parameter to that effect, or does not generate a process parameter and a timing parameter.

Further, in a case where the content producer has not performed an editing operation on the user I/F 60, the editing unit 22 performs, as an editing process, the same processing as the processing performed with respect to the immediately previous frame, for example.

In step S14, the monitor 23 displays the image of edited content (standard content) outputted by the special effect generating unit 74, and the processing proceeds to step S15.

When the image of edited content is displayed on the monitor 23 in this way, the content producer can confirm the image of edited content.

In step S15, the control data generating unit 61 generates control data (standard control data) including the process parameter (the process parameter with respect to each of the material contents #1 and #2) and the timing parameter that are generated in step S12, and supplies the control data to the control data recording unit 67. The processing then proceeds to step S16.

In step S16, the control data recording unit 67 records (stores) the control data supplied from the control data generating unit 61 in association with the synchronization data supplied from the synchronization data generating unit 66, and further, outputs the control data (standard control data) associated with the synchronization data to the transmitting unit 24₃ (FIG. 1). The processing then proceeds to step S17.

In step S17, the zoom processing unit 71ᵢ determines whether or not the image of the material content #i from the camera 11ᵢ has ended.

If it is determined in step S17 that the image of the material content #i from the camera 11ᵢ has not ended, that is, if the image of the next one frame of the material content #i has been supplied from the camera 11ᵢ to the editing unit 22, the processing returns to step S11, and subsequently, the same processing is repeated.

If it is determined in step S17 that the image of the material content #i from the camera 11ᵢ has ended, that is, if the image of the next one frame of the material content #i has not been supplied from the camera 11ᵢ to the editing unit 22, the processing ends.

It should be noted that in a live broadcast, the image of the material content #i outputted by the camera 11ᵢ is immediately transmitted by the transmitting unit 24ᵢ, and the control data outputted by the control data recording unit 67 is immediately transmitted by the transmitting unit 24₃.

FIG. 7 is a flowchart illustrating processing in the setting unit 21 and the editing unit 22 in a case where a so-called taped broadcast is performed.

In steps S31 through S34, processes that are the same as in steps S11 through S14 in FIG. 6 are respectively performed. Thus, in step S34, the image of edited content (standard content) outputted by the special effect generating unit 74 is displayed on the monitor 23.

Then, the processing proceeds from step S34 to step S35, and the control unit 62 determines whether or not to terminate an editing process on the image of one frame of the material content #i from the camera 11ᵢ which is acquired in step S31.

If it is determined in step S35 not to terminate an editing process on the image of one frame of the material content #i, that is, if the content producer who has seen the image of edited content displayed on the monitor 23 in step S34 is not satisfied with the image of edited content, and has performed an editing operation on the user I/F 60 anew so as to perform another editing process, the processing returns to step S32, where the control data generating unit 61 generates a process parameter and a timing parameter in response to an operation signal supplied from the user I/F 60 in correspondence to the new editing operation made by the content producer. Subsequently, the same processing is repeated.

Also, if it is determined in step S35 to terminate an editing process on the image of one frame of the material content #i, that is, if the content producer who has seen the image of edited content displayed on the monitor 23 in step S34 is satisfied with the image of edited content, and has operated the user I/F 60 so as to terminate an editing process, or to perform an editing process on the image of the next one frame, the processing proceeds to step S36.

In step S36, the control data generating unit 61 generates control data (standard control data) including the process parameter (the process parameter with respect to each of the material contents #1 and #2) and the timing parameter that are generated in step S32, and supplies the control data to the control data recording unit 67. Further, in step S36, the control data recording unit 67 records the control data supplied from the control data generating unit 61 in association with the synchronization data supplied from the synchronization data generating unit 66. The processing then proceeds to step S37.

In step S37, the zoom processing unit 71ᵢ determines whether or not the image of the material content #i from the camera 11ᵢ has ended.

If it is determined in step S37 that the image of the material content #i from the camera 11ᵢ has not ended, that is, if the image of the next one frame of the material content #i has been supplied from the camera 11ᵢ to the editing unit 22, the processing returns to step S31, and subsequently, the same processing is repeated.

If it is determined in step S37 that the image of the material content #i from the camera 11ᵢ has ended, that is, if the image of the next one frame of the material content #i has not been supplied from the camera 11ᵢ to the editing unit 22, the processing proceeds to step S38.

In step S38, the control data recording unit 67 outputs the control data (standard control data) recorded in association with the synchronization data, to the transmitting unit 24₃ (FIG. 1), and the processing ends.

It should be noted that in the case of a taped broadcast, at the broadcast time, the image of the material content #i outputted by the camera 11ᵢ is transmitted by the transmitting unit 24ᵢ, and the control data outputted by the control data recording unit 67 is transmitted by the transmitting unit 24₃.

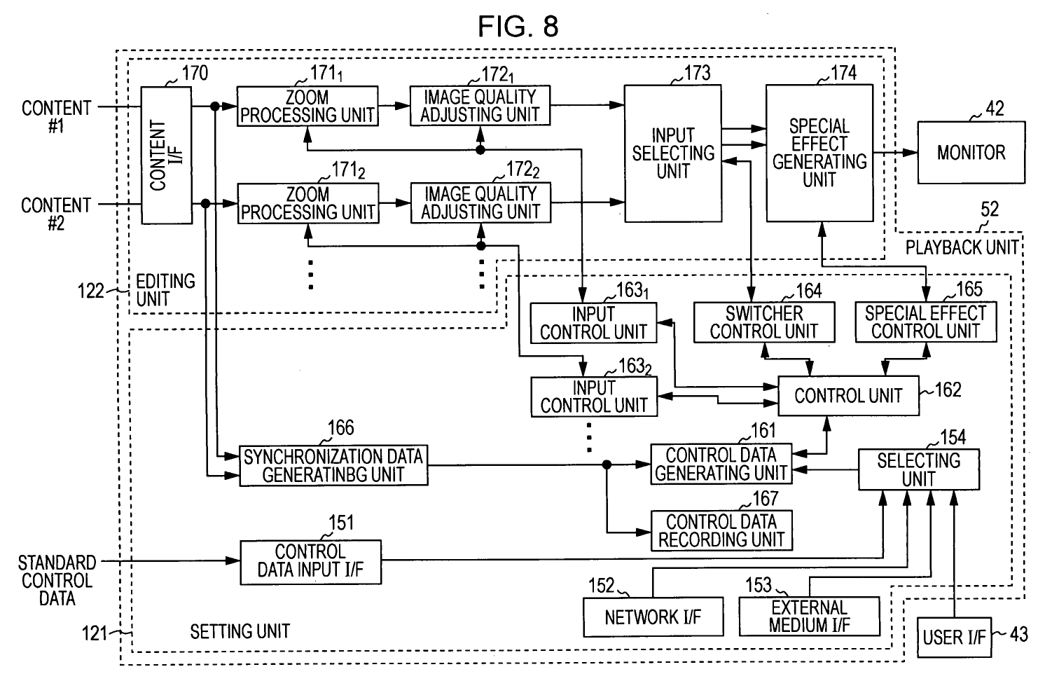

Next, FIG. 8 shows a configuration example of the playback unit 52 in FIG. 1.

In FIG. 8, the playback unit 52 includes a setting unit 121, an editing unit 122, and the like.

The setting unit 121 includes a control data input I/F 151, a network I/F 152, an external medium I/F 153, a selecting unit 154, a control data generating unit 161, a control unit 162, input control units 163₁ and 163₂, a switcher control unit 164, a special effect control unit 165, a synchronization data generating unit 166, a control data recording unit 167, and the like. The setting unit 121 receives control data, and controls the editing unit 122 in accordance with the control data.

Also, in response to an editing operation on the user I/F 43 made by the user (end user) of the receiving-side device 2 (FIG. 1) to instruct editing, the setting unit 121 generates a new process parameter and a new timing parameter, and controls the editing unit 122 in accordance with the new process parameter and the new timing parameter.

That is, control data (standard control data) supplied to the playback unit 52 from the receiving unit 513 (FIG. 1) is supplied to the control data input I/F 151. The control data input I/F 151 receives the control data from the receiving unit 51₃, and supplies the control data to the selecting unit 154.

The network I/F 152 downloads and receives control data from a server on the network, and supplies the control data to the selecting unit 154.

The external medium 44 (FIG. 1) is mounted on the external medium I/F 153. The external medium I/F 153 reads and receives control data from the external medium 44 mounted thereon, and supplies the control data to the selecting unit 154.

In this regard, in addition to being transmitted from the broadcasting device 12, control data generated by the broadcasting device 12 can be uploaded to a server on the network, or can be recorded onto the external medium 44 and distributed.

Likewise, control data generated by an editing operation performed by the user of the receiving-side device 2 or another user can be also uploaded to a server on the network, or can be recorded onto the external medium 44.

Further, control data received by the control data input I/F 151 or the network I/F 152 can be recorded onto the external medium 44.

With the network I/F 152, as described above, control data uploaded to a server on the network can be downloaded.

Also, with the external medium I/F 153, as described above, control data recorded onto the external medium 44 can be read.

In addition to control data supplied from each of the control data input I/F 151, the network I/F 152, and the external medium I/F 153 to the selecting unit 154 as described above, an operation signal responsive to a user's operation is supplied to the selecting unit 154 from the user I/F 43.

The selecting unit 154 selects, in accordance with an operation signal or the like from the user I/F 43, control data supplied from one of the control data input I/F 151, the network I/F 152, and the external medium I/F 153, and supplies the control data to the control data generating unit 161.

Also, upon supply of an operation signal responsive to an editing operation (hereinafter, also referred to as an editing operation signal) from the user I/F 43, the selecting unit 154 preferentially selects the editing operation signal, and supplies the editing operation signal to the control data generating unit 161.

In addition to control data or an operation signal supplied from the selecting unit 154, synchronization data from the synchronization data generating unit 166 is supplied to the control data generating unit 161.

In this regard, as described above, for example, in the broadcasting device 12, the control data supplied to the control data generating unit 161 from the selecting unit 154 is associated with synchronization data. This synchronization data associated with the control data is also referred to as control synchronization data.

Also, the synchronization data supplied to the control data generating unit 161 from the synchronization data generating unit 166 is also referred to as generated synchronization data.

In a case when control data is supplied from the selecting unit 154, the control data generating unit 161 supplies the control data from the selecting unit 154 to the control data recording unit 167.

Further, the control data generating unit 161 detects, from among pieces of control data from the selecting unit 154, control data associated with control synchronization data that matches the generated synchronization data from the synchronization data generating unit 166, and supplies a process parameter and a timing parameter included in the control data to the control unit 162.

In a case when an operation signal is supplied from the selecting unit 154, like the control data generating unit 61 in FIG. 2, the control data generating unit 161 generates a new process parameter with respect to each of the material contents #1 and #2, and generates a new timing parameter, in response to an operation signal from the selecting unit 154. Further, the control data generating unit 161 generates new control data including the new process parameter and the new timing parameter.

Then, the control data generating unit 161 supplies the new process parameter and the new timing parameter to the control unit 162, and supplies the new control data to the control data recording unit 167.

In this regard, as opposed to new control data generated by the control data generating unit 161 in response to an operation signal from the selecting unit 154, and a new process parameter and a new timing parameter that are included in the new control data, control data supplied from the selecting unit 154 to the control data generating unit 161, and a process parameter and a timing parameter that are included in the control data, are respectively also referred to as already-generated control data, and already-generated process parameter and already-generated timing parameter.

Like the control unit 62 in FIG. 2, the control unit 162 controls individual units that constitute the setting unit 121.

That is, for example, the control unit 162 controls the input control units 163₁ and 163₂, the switcher control unit 164, or the special effect control unit 165, in accordance with a process parameter and a timing parameter from the control data generating unit 161.

Also, the control unit 162 controls the control data generating unit 161, for example.

Like the input control unit 63₁ in FIG. 2, the input control unit 163₁ controls a zoom processing unit 171₁ and an image quality adjusting unit 172₁ that constitute the editing unit 122, in accordance with control by the control unit 162.

Like the input control unit 63₂ in FIG. 2, the input control unit 163₂ controls a zoom processing unit 171₂ and an image quality adjusting unit 172₂ that constitute the editing unit 122, in accordance with control by the control unit 162.

Like the switcher control unit 64 in FIG. 2, the switcher control unit 164 controls an input selecting unit 173 that constitutes the editing unit 122, in accordance with control by the control unit 162.

Like the special effect control unit 65 in FIG. 2, the special effect control unit 165 controls a special effect generating unit 174 that constitutes the editing unit 122, in accordance with control by the control unit 162.

Like the synchronization data generating unit 66 in FIG. 2, the synchronization data generating unit 166 generates synchronization data, and supplies the synchronization data to the control data generating unit 161 and the control data recording unit 167.

That is, the image of the material content #1 supplied from the receiving unit 51₁ (FIG. 1) to the playback unit 52, and the image of the material content #2 supplied from the receiving unit 51₂ to the playback unit 52 are supplied to the synchronization data generating unit 166 from a content I/F 170 that constitutes the editing unit 122.

The synchronization data generating unit 166 generates, as synchronization data, information that identifies each frame (or field) of the image of the material content #1, and supplies the synchronization data for each frame to the control data recording unit 167.

Further, the synchronization data generating unit 166 generates synchronization data also with respect to the image of the material content #2, and supplies the synchronization data to the control data recording unit 167.

The control data recording unit 167 records (stores) the control data supplied from the control data generating unit 161 in association with the synchronization data supplied from the synchronization data generating unit 166.

That is, in a case when new control data is supplied from the control data generating unit 161, like the control data recording unit 67 in FIG. 2, the control data recording unit 167 records the new control data onto a built-in recording medium (not shown), the external medium 44, or the like in association with synchronization data from the synchronization data generating unit 166.

It should be noted that in a case when already-generated control data is supplied from the control data generating unit 161, since the already-generated control data has been already associated with synchronization data, the control data recording unit 167 records the already-generated control data associated with the synchronization data.

The editing unit 122 includes the content I/F 170, the zoom processing units 171₁ and 171₂, the image quality adjusting units 172₁ and 172₂, the input selecting unit 173, the special effect generating unit 174, and the like.

The editing unit 122 receives the image of the material content #1 supplied to the playback unit 52 from the receiving unit 51₁, and the image of the material content #2 supplied to the playback unit 52 from the receiving unit 51₂, generates the image of edited content by editing the material contents #1 and #2 in accordance with a process parameter and a timing parameter that are included in control data received by the setting unit 121, and outputs the image to the monitor 42.

That is, the content I/F 170 receives the image of the material content #1 supplied to the playback unit 52 from the receiving unit 51₁, and the image of the material content #2 supplied to the playback unit 52 from the receiving unit 51₂, and supplies the material content #1 to the zoom processing unit 171₁ and supplies the material content #2 to the zoom processing unit 171₂.

Also, the content I/F 170 supplies the material contents #1 and #2 to the synchronization data generating unit 166.

Like the zoom processing unit 71ᵢ in FIG. 2, the zoom processing unit 171ᵢ performs a process of extracting an area to be outputted as the image of edited content, from the image of the material content #i from the content I/F 70, in accordance with control by the input control unit 163ᵢ.

Further, like the zoom processing unit 71ᵢ in FIG. 2, the zoom processing unit 171ᵢ performs the processing (resizing) of changing the size of an extracted image as necessary, thereby converting the extracted image into an image of a size that matches the image of edited content, and supplies the image to the image quality adjusting unit 172i.

Like the image quality adjusting unit 72ᵢ in FIG. 2, the image quality adjusting unit 172ᵢ performs a process of adjusting the image quality of the image of the material content #i from the zoom processing unit 171ᵢ, in accordance with control by the input control unit 163ᵢ.

It should be noted that the kind of process performed with respect to the image of the material content #i in the zoom processing unit 171ᵢ and the image quality adjusting unit 172ᵢ are determined by a process parameter with respect to the material content #i which is supplied from the control data generating unit 161 to the control unit 162.

Like the input selecting unit 73 in FIG. 2, the input selecting unit 173 selects an image(s) to be outputted as the image of edited content, from among the image of the material content #1 from the image quality adjusting unit 172₁, and the image of the material content #2 from the image quality adjusting unit 172₂, in accordance with control by the switcher control unit 164, and supplies the selected image to the special effect generating unit 174.

In this regard, as in the case of FIG. 2, the image to be selected by the input selecting unit 173 is determined by the timing parameter supplied from the control data generating unit 161 to the control unit 162.

Like the special effect generating unit 74 in FIG. 2, the special effect generating unit 174 performs a process of adding a special effect to one or more images supplied from the input selecting unit 173, in accordance with control by the special effect control unit 165, and outputs the image obtained as a result as the image of edited content.

In this regard, as in the case of FIG. 2, the kind of process in the special effect generating unit 274, that is, the kind of special effect added to an image are determined by the process parameter with respect to the material content #i, which is supplied to the control unit 162 from the control data generating unit 161.

The image of edited content outputted by the special effect generating unit 174 is supplied to the monitor 42 and displayed.

In this regard, in the editing unit 122 configured as described above, editing of the material contents #1 and #2 is performed in accordance with an already-generated process parameter and an already-generated timing parameter that are included in already-generated control data received by the setting unit 121 and, in addition, editing of the material contents #1 and #2 is performed also in accordance with an editing operation on the user I/F 43 made by the user.

That is, as described above, in the setting unit 121, in a case when an editing operation signal responsive to an editing operation is supplied from the user I/F 43, the selecting unit 154 preferentially selects the editing operation signal, and supplies the editing operation signal to the control data generating unit 161.

In a case when an editing operation signal is supplied from the selecting unit 154, the control data generating unit 161 generates a new process parameter and a new timing parameter in response to the editing operation signal, and supplies the new process parameter and the new timing parameter to the control unit 162.

In this case, the control unit 162 controls the input control units 163₁ and 163₂, the switcher control unit 164, or the special effect control unit 165 in accordance with the new process parameter and the new timing parameter from the control data generating unit 161. In the editing unit 122, editing of the material contents #1 and #2 is performed in accordance with the control.

Therefore, in the editing unit 122, when an editing operation on the user I/F 43 is performed, editing is performed in accordance with a new process parameter and a new timing parameter that are generated in response to the editing operation, instead of an already-generated process parameter and an already-generated timing parameter that are included in already-generated control data.

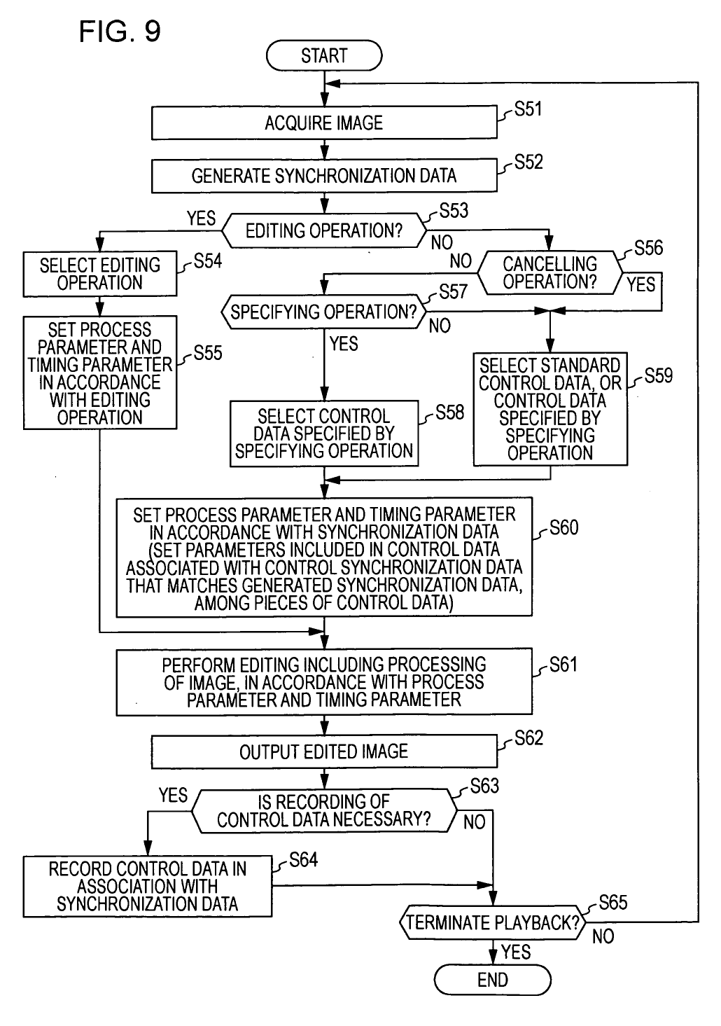

Next, referring to FIG. 9, processing in the playback unit 52 in FIG. 8 will be described.

It should be noted that in the broadcasting device 12 (FIG. 1), instead of transmitting standard control data together with the material contents #1 and #2, for example, the standard control data can be uploaded to a server on the network, and received in the playback unit 52 by downloading the standard control data from the server on the network by the network I/F 152. In this example, however, it is assumed that standard control data is transmitted from the broadcasting device 12 together with the material contents #1 and #2.

The material contents #1 and #2, and the control data (standard control data) that are transmitted from the broadcasting device 12 are received by the receiving device 41.

That is, the receiving unit 51₁ receives the material content #1, and supplies the material content #1 to the playback unit 52. The receiving unit 51₂ receives the material content #2, and supplies the material content #1 to the playback unit 52. Also, the receiving unit 51₃ receives standard control data, and supplies the standard control data to the playback unit 52.

In the playback unit 52, in step S51, after waiting for the image of one frame of material content #i (i=1, 2) to be supplied from the receiving unit 51ᵢ, the content I/F 170 receives and acquires the image of one frame of the material content #i, and supplies the image to the zoom processing unit 171ᵢ and the synchronization data generating unit 166.

Also, in the playback unit 52, the control data input I/F 151 receives and acquires the control data supplied from the receiving unit 51₃, and supplies the control data to the selecting unit 154.

In addition, if possible, the network I/F 152 or the external medium 153 also receives control data, and supplies the control data to the selecting unit 154.

Thereafter, the processing proceeds from step S51 to step S52, where the synchronization data generating unit 166 generates synchronization data (generated synchronization data) of the image of one frame of the material content #i supplied from the content I/F 170, and supplies the synchronization data to the control data generating unit 161 and the control data recording unit 167. The processing then proceeds to step S53.

In step S53, the selecting unit 154 determines whether or not the immediately previous operation on the user I/F 43 is an editing operation.

If it is determined in step S53 that the immediately previous operation on the user I/F 43 is an editing operation, that is, if the immediately previous operation signal supplied from the user I/F 43 to the selecting unit 154 is an editing operation signal, the processing proceeds to step S54, where the selecting unit 154 selects the immediately previous editing operation signal from the user I/F 43, and supplies the editing operation signal to the control data generating unit 161. The processing then proceeds to step S55.

In step S55, in response to the editing operation signal from the user I/F 43, the control data generating unit 161 generates a new process parameter and a new timing parameter with respect to each of the material contents #1 and #2, and supplies the new process parameter and the new timing parameter to the control unit 162.

For example, the control unit 162 sets the new process parameter and the new timing parameter from the control data generating unit 161 to necessary blocks among the input control units 163₁ and 163₂, the switcher control unit 164, and the special effect control unit 165.

Further, in step S55, the control data generating unit 161 generates new control data including the new process parameter and the new timing parameter, and supplies the control data to the control data recording unit 167. The processing then proceeds to step S61.

In step S61, as in the case of step S13 in FIG. 6, the zoom processing units 171₁ and 171₂, the image quality adjusting units 172₁ and 172₂, the input selecting unit 173, and the special effect generating unit 174 that constitute the editing unit 122 perform an editing process including image processing on the image acquired in step S51, in accordance with the new process parameter and the new timing parameter generated by the control data generating unit 161.

That is, in a case when a new process parameter is set from the control unit 162, the input control unit 163ᵢ adjusts the zoom processing unit 171ᵢ and the image quality adjusting unit 172ᵢ in accordance with the new process parameter.

Also, in a case when a new timing parameter is set from the control unit 162, the switcher control unit 164 controls the input selecting unit 173 in accordance with the new timing parameter.

Further, in a case when a new process parameter is set from the control unit 162, the special effect control unit 165 controls the special effect generating unit 174 in accordance with the new process parameter.

In accordance with control by the input control unit 163ᵢ, the zoom processing unit 171ᵢ extracts an extracted image to be outputted as the image of edited content, from the image of the material content #i from the content I/F 170 and further, as necessary, converts the extracted image into an image of a size that matches the image of edited content, and supplies the image to the image quality adjusting unit 172ᵢ.

In accordance with control by the input control unit 163ᵢ, the image quality adjusting unit 172ᵢ adjusts the image quality of the image (extracted image) of the material content #i from the zoom processing unit 171ᵢ, and supplies the image to the input selecting unit 173.

In accordance with control by the switcher control unit 164, the input selecting unit 173 selects an image to be outputted as the image of edited content, from among the image of the material content #1 from the image quality adjusting unit 172₁, and the image of the material content #2 from the image quality adjusting unit 172₂, and supplies the image to the special effect generating unit 174.

In accordance with control by the special effect control unit 165, the special effect generating unit 174 adds a special effect to one or more images supplied from the input selecting unit 173, and outputs the image obtained as a result to the monitor 42, as the image of edited content (standard content).

It should be noted that in a case where various conversion processes using the DRC described above are performed in the zoom processing unit 171ᵢ or the image quality adjusting unit 172ᵢ, tap coefficients used for performing the various conversion processes are stored. The tap coefficient to be used by the zoom processing unit 171ᵢ or the image quality adjusting unit 172ᵢ is specified by the process parameter.

Thereafter, the processing proceeds from step S61 to step S62, where the image of edited content (edited image) outputted by the special effect generating unit 174 is displayed on the monitor 42. The processing then proceeds to step S63.

In this way, in a case when an editing operation on the user I/F 43 is performed, editing of the images of the material contents #1 and #2 is performed in accordance with the editing operation, and the image of edited content obtained as a result is displayed on the monitor 42.

Therefore, the user can perform editing with high degree of freedom, not with respect to the image of standard content obtained as a result of editing with the broadcasting device 12, but with respect to the material contents #1 and #2, thereby making it possible to enhance the degree of freedom of editing, and provide content that is appropriate for the user.

Also, the process parameter is generated for each material content in response to an editing operation on the user I/F 43. Thus, an enhanced degree of freedom is achieved in terms of image quality adjustment or the like with respect to each of a plurality of material contents (in this example, the material contents #1 and #2) each serving as the material of edited content, thus enabling optimal adjustment.

In step S63, the control data recording unit 167 determines whether or not recording of control data is necessary.

If it is determined in step S63 that recording of control data is necessary, that is, if, for example, the user has made, by operating the user I/F 43, a setting for the playback unit 52 to perform recording of control data, the processing proceeds to step S64, where the control data recording unit 167 records the control data used in the immediately previous editing process in step S61, which in the present case is new control data supplied from the control data generating unit 161, onto the external medium 44 (FIG. 1), for example, in association with synchronization data supplied from the synchronization data generating unit 166. The processing then proceeds to step S65.

In this regard, by recording new control data onto the external medium 44 in association with synchronization data in this way, thereafter, editing in the editing unit 122 can be performed in accordance with the control data recorded on the external medium 44. Thus, it is not necessary for the user to perform the same editing operation again.

On the other hand, if it is determined in step S53 that the immediately previous operation on the user I/F 43 is not an editing operation, the processing proceeds to step S56, where the selecting unit 154 determines whether or not the immediately previous operation on the user I/F 43 is a cancelling operation for instructing cancelling of an editing operation.

If it is determined in step S56 that the immediately previous operation on the user I/F 43 is not a cancelling operation, the processing proceeds to step S57, where the selecting unit 154 determines whether or not the immediately previous operation on the user I/F 43 is a specifying operation for specifying control data.

If it is determined in step S57 that the immediately previous operation on the user I/F 43 is a specifying operation, that is, if the immediately previous operation signal supplied to the selecting unit 154 from the user I/F 43 is an operation signal responsive to a specifying operation, the processing proceeds to step S58, where the selecting unit 154 selects the control data specified by the immediately previous specifying operation on the user I/F 43 (hereinafter, also referred to as specified control data), from among pieces of control data respectively supplied from each of the control data input I/F 151, the network I/F 152, and the external medium I/F 153, and supplies the control data to the control data generating unit 161. The processing then proceeds to step S60.

In step S60, in accordance with generated synchronization data generated by the synchronization data generating unit 166, setting of a process parameter and a timing parameter that are included in the specified control data from the selecting unit 154 is performed.

That is, in step S60, the control data generating unit 161 detects, from the specified control data from the selecting unit 154, already-generated control data associated with control synchronization data that matches the generated synchronization data from the synchronization data generating unit 166, and supplies an already-generated process parameter and an already-generated timing parameter included in the control data to the control unit 162.

For example, the control unit 162 sets the already-generated process parameter and the already-generated timing parameter from the control data generating unit 161 to necessary blocks among the input control units 163₁ and 163₂, the switcher control unit 164, and the special effect control unit 165.

Further, in step S60, the control data generating unit 161 supplies the already-generated control data from the selecting unit 154 to the control data recording unit 167. The processing then proceeds to step S61.

In this case, in step S61, as in the case of step S13 in FIG. 6, the zoom processing units 171₁ and 171₂, the image quality adjusting units 172₁ and 172₂, the input selecting unit 173, and the special effect generating unit 174 that constitute the editing unit 122 perform an editing process including image processing on the image acquired in step S51, in accordance with the already-generated process parameter and the already-generated timing parameter included in the already-generated control data detected by the control data generating unit 161.

The image of edited content obtained through the editing process in the editing unit 122 is outputted from (the special effect generating unit 174 of) the editing unit 122 to the monitor 42.

Thereafter, the processing proceeds from step S61 to step S62, where the image of edited content from the editing unit 122 is displayed on the monitor 42. The processing then proceeds to step S63.

In this way, in a case when a specifying operation on the user I/F 43 is performed, editing of the images of the material contents #1 and #2 is performed in accordance with an already-generated process parameter and an already-generated timing parameter that are included in the already-generated control data specified by the specifying operation, and the image of edited content obtained as a result is displayed on the monitor 42.

Therefore, for example, as described above, in a case where new control data generated in accordance with an editing operation exists as already-generated control data that was recorded onto the external medium 44 (FIG. 1) in step S64 performed in the past, by specifying the already-generated control data by a specifying operation, the user can view the image of edited content obtained by an editing operation performed in the past. It should be noted, however, that it is also necessary to previously record the material contents #1 and #2 necessary for the editing for obtaining the edited content.

Also, in a case where, for example, standard control data received by the control data input I/F 151 exists as already-generated control data that was recorded onto the external medium 44 (FIG. 1) in step S64 performed in the past, by specifying the already-generated control data by a specifying operation, the user can view the image of edited content obtained by editing according to the standard control data received in the past.

In step S63, as described above, the control data recording unit 167 determines whether or not recording of control data is necessary, and if it is determined that recording of control data is necessary, the processing proceeds to step S64.

In step S64, the control data recording unit 167 records the control data used in the immediately previous editing process in step S61, that is, in the present case, already-generated control data associated with synchronization data which is supplied from the control data generating unit 161, onto the external medium 44, for example. The processing then proceeds to step S65.

In this regard, when standard control data is specified by a specifying operation, in step S64, the standard control data is recorded onto the external medium 44.

Also, for example, when an editing operation is made by the user after a specifying operation for specifying standard control data, in step S64, new control data generated in response to the editing operation is recorded onto the external medium 44, instead of the standard control data.

In this case, on the external medium 44, the standard control data, and new control data generated in response to the editing operation are recorded as already-generated control data in a so-called mixed (synthesized) state.

In a case when such already-generated control data existing in a mixed state of standard control data and new control data is specified by a specifying operation, in the editing unit 122, for a frame identified by synchronization data associated with the standard control data, editing is performed in accordance with a process parameter and a timing parameter included in the standard control data, and for a frame identified by synchronization data associated with the new control data, editing is performed in accordance with a process parameter and a timing parameter included in the new control data.

Therefore, in this case, a part of the obtained image of edited content is an image obtained by editing performed by the content producer, and the remainder is an image obtained by editing according to an editing operation made by the user.

On the other hand, if it is determined in step S56 that the immediately previous operation on the user I/F 43 is a cancelling operation for instructing cancellation of an editing operation, that is, if the immediately previous operation signal supplied to the selecting unit 154 from the user I/F 43 is an operation signal responsive to a cancelling operation, the processing proceeds to step S59. In step S59, the selecting unit 154 selects, as specified control data, control data specified by a specifying operation immediately before cancellation is instructed by a cancelling operation, from among pieces of control data respectively supplied from the control data input I/F 151, the network I/F 152, and the external medium I/F 153.

In this regard, in a case where no specifying operation has been made before cancellation is instructed by a cancelling operation, in step S59, the selecting unit 154 selects, for example, standard control data supplied from the control data input I/F 151, as specified control data.

In step S59, upon selecting specified control data, the selecting unit 154 supplies the specified control data to the control data generating unit 161. The processing then proceeds to step S60, and subsequently, the same processing is performed.

If it is determined in step S57 that the immediately previous operation on the user I/F 43 is not a cancelling operation, that is, if the immediately previous operation on the user I/F 43 is none of an editing operation, a cancelling operation, and a specifying operation, the processing proceeds to step S59.

In this case, in step S59, the selecting unit 154 selects standard control data supplied from the control data input I/F 151 as specified control data, and subsequently, the same processing is performed.

Therefore, for example, as first, in a state where the user has not operated the user I/F 43, editing is performed in the editing unit 122 in accordance with a process parameter and a timing parameter included in standard control data received by the control data input I/F 151. As a result, on the monitor 42, an image of standard content on which the intention of the content producer is reflected is displayed as the image of edited content.

Thereafter, when the user makes an editing operation on the user I/F 43, in the editing unit 122, editing is performed in accordance with a new process parameter and a new timing parameter generated in response to the editing operation, instead of the process parameter and the timing parameter included in the standard control data. As a result, on the monitor 42, the image of content suited to the user's preferences is displayed as the image of edited content.

When the user further makes a cancelling operation on the user I/F 43 thereafter, in the editing unit 22, editing is performed again in accordance with the control data used immediately before the editing operation is made, that is, in the present case, the process parameter and the timing parameter included in the standard control data, instead of the new process parameter and the new timing parameter generated in response to the editing operation. As a result, on the monitor 42, the image of standard content is displayed as the image of edited content again.

Therefore, in the editing unit 122, when the user makes an editing operation, editing is performed in accordance with the editing operation, and when the user makes a cancelling operation, editing is performed so as to reflect the intention of the content producer.

On the other hand, if it is determined in step S63 that recording of control data is not necessary, that is, if the playback unit 52 is not set to perform recording of control data, the processing skips step S64 and proceeds to step S65.

In step S65, the control unit 162 determines whether or not to terminate playback of edited content.

If it is determined in step S65 not to terminate playback of edited content, that is, if the user has not operated the user I/F 43 so as to terminate playback of edited content, the processing returns to step S51.

If it is determined in step S65 to terminate playback of edited content, that is, if the user has operated the user I/F 43 so as to terminate playback of edited content, the processing ends.

In this way, in the broadcasting device 12, the control data generating unit 61 (FIG. 2) generates a process parameter for each of the material contents #1 and #2, which is used for processing each of the material contents #1 and #2 as a plurality of contents, and a timing parameter indicating the output timing at which the material contents #1 and #2 are outputted as edited content that is content on which editing has been performed, and the editing unit 22 edits the material contents #1 and #2 in accordance with the process parameter and the timing parameter to generate edited content.

Further, in the broadcasting device 12, the control data recording unit 67 outputs control data including a process parameter and a timing parameter and used for editing the material contents #1 and #2 to generate edited content, and the transmitting unit 24₁ (FIG. 1), the transmitting unit 24₂, and the transmitting unit 24₃ respectively transmit the material content #1, the material content #2, and the control data (standard control data).

On the other hand, in the receiving device 41, the content I/F 170 of the playback unit 52 (FIG. 8) receives the material contents #1 and #2 from the broadcasting unit 12, and the control data input I/F 151, the network I/F 152, or the external medium I/F 153 receives the standard control data from the broadcasting device 12.

Further, in the receiving unit 41, in accordance with the process parameter and the timing parameter included in the standard control data, the editing unit 122 of the playback unit 52 edits the material contents #1 and #2 to generate edited content (standard content).

Therefore, in the receiving device 41, editing for processing the material contents #1 and #2 is performed in accordance with the process parameter set for each of the material contents #1 and #2, thereby making it possible to enhance the degree of freedom of editing.

Further, in a case when an editing operation for instructing editing is made by the user, in the setting unit 121 of the playback unit 52, the control data generating unit 161 (FIG. 8) generates a new process parameter and a new process parameter in response to the editing operation made by the user, and in the editing unit 122, editing is performed in accordance with the new process parameter and the new timing parameter, instead of the process parameter and the timing parameter included in the standard control data. Thus, the user can perform editing with high degree of freedom, and as a result of such editing with high degree of freedom, provision of content that is appropriate for the user can be received.

Also, in a case when a cancelling operation for instructing cancellation of an editing operation is made by the user, in the editing unit 122, editing is performed in accordance with, for example, the process parameter and the timing parameter included in the standard control data again, instead of the new process parameter and the new timing parameter. Thus, the user can enjoy edited content on a part of which editing by the content producer is reflected, and on the remainder of which editing by the user is reflected.

That is, it is not necessary for the user to perform editing of the material contents #1 and #2 all by himself/herself, and can perform a part of the editing by using the result of editing by the content producer.

It should be noted that in the broadcasting device 12 and the receiving device 41, as described above, editing of sound can be also performed in addition to editing of an image.

While in the broadcasting device 12 and the receiving device 41 the two material contents #1 and #2 are subjected to editing, three or more material contents can be set as the plurality of material contents that are subjected to editing.

Further, in the broadcasting device 12 and the receiving device 41, it is possible to perform editing including the process of, with one of a plurality of material contents as a telop, superimposing the telop on the image of another material content.

Next, the series of processes described above can be executed by either of hardware and software. If the series of processes is to be executed by software, a program that constitutes the software is installed onto a general-purpose computer or the like.

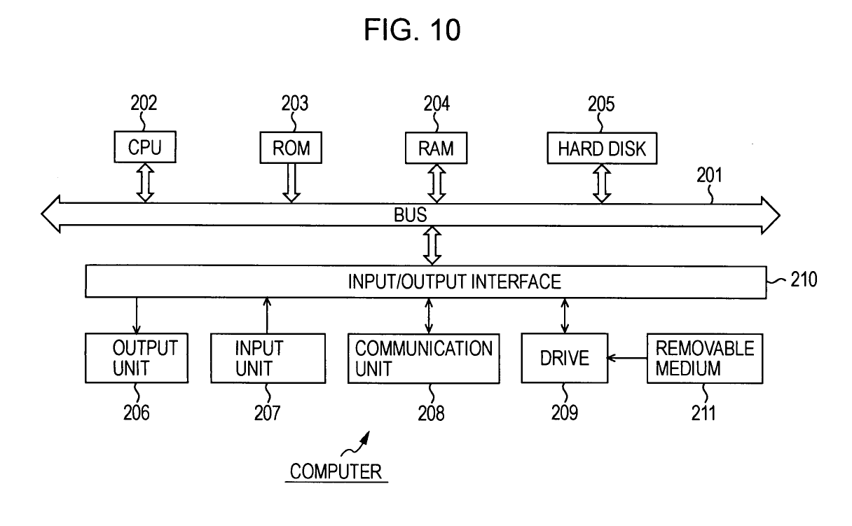

FIG. 10 shows a configuration example of an embodiment of a computer onto which a program that executes the series of processes described above is installed.

The program can be recorded in advance onto a hard disk 205 or a ROM 203 as a recording medium built in a computer.

Alternatively, the program can be temporarily or permanently stored (recorded) onto a removable recording medium 211 such as a CD-ROM (Compact Disc Read Only Memory), an MO (Magneto Optical) disc, a DVD (Digital Versatile Disc), a magnetic disc, or a semiconductor memory. Such a removable recording medium 211 can be provided as so-called package software.

It should be noted that other than being installed onto a computer from the removable recording medium 211 as described above, the program can be transferred from a download site to the computer by radio via an artificial satellite for digital satellite broadcasting, or can be transferred to the computer by wire via a network such as the LAN (Local Area Network) or the Internet, and on the computer, the program thus transferred to the computer can be received by a communication unit 208, and installed onto the built-in hard disk 205.

The computer has a built-in CPU (Central Processing Unit) 202. An input/output interface 210 is connected to the CPU 202 via a bus 201. When a command is inputted as the user makes an operation or the like on an input unit 207 configured by a keyboard, a mouse, or a microphone via the input/output interface 210, in accordance with the command, the CPU 202 executes a program recorded on a ROM (Read Only Memory) 203. Alternatively, the CPU 202 also executes a program stored on the hard disk 205, a program that is transferred from a satellite or a network, and is received by the communication unit 208 and installed onto the hard disk 205, or a program that is read from the removable recording medium 211 mounted on a drive, and is installed onto the hard disk 205, by loading the program onto the RAM (Random Access Memory) 204. Thus, the CPU 202 performs processing according to the flowchart described above, or processing performed on the basis of the configuration of the block diagram described above. Then, as necessary, the CPU 202 causes the processing result to be outputted from an output unit 206 configured by an LCD (Liquid Crystal Display), a speaker, or the like, via the input/output interface 210, causes the processing result to be transmitted from the communication unit 208, or causes the processing result to be recorded onto the hard disk 205.

In this regard, in this specification, processing steps describing a program for causing a computer to execute various processes may not necessarily be processed time sequentially in the order described in the flowchart, but also include processes that are executed in a parallel fashion or independently (for example, parallel processes or object-based processes).

Also, the program may be one that is processed by a single computer, or may be one that is processed in a distributed manner across a plurality of computers.

It should be noted that an embodiment of the present invention is not limited to the above-described embodiment, and various modifications are possible without departing from the scope of the present invention.

That is, while this embodiment is directed to a case where the present invention is applied to a broadcasting system, other than this, the present invention can be also applied to, for example, a communication system that transmits data via a network such as the Internet.

What is claimed is:

1. A data processing device that processes content, comprising:
content receiving means for receiving a plurality of contents;
control data receiving means for receiving control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and
editing means for generating the edited content, by editing the plurality of contents in accordance with the process parameter and the timing parameter included in the control data.

2. The data processing device according to claim 1, further comprising generating means for generating a new process parameter and a new timing parameter in response to an editing operation made by a user for instructing editing,
wherein the editing means performs editing in response to the editing operation, in accordance with the new process parameter and the new timing parameter, instead of the process parameter and the timing parameter included in the control data.

3. The data processing device according to claim 2, wherein the editing means performs editing in response to a cancelling operation made by the user for instructing cancellation of the editing operation, in accordance with the process parameter and the timing parameter included in the control data, instead of the new process parameter and the new timing parameter.

4. The data processing device according to claim 2, further comprising recording means for recording the control data, and new control data including the new process parameter and the new timing parameter.

5. The data processing device according to claim 2, wherein the editing means performs editing including a process of adjusting an image quality of an image included in each of the contents.

6. The data processing device according to claim 2, wherein the editing means performs editing including a process of improving a resolution of an image included in each of the contents.

7. The data processing device according to claim 2, wherein the editing means performs editing including a process of changing a size of an image included in each of the contents.

8. The data processing device according to claim 2, wherein the editing means performs editing including a process of extracting an area to be outputted as the edited content, from an image included in each of the contents.

9. The data processing device according to claim 2, wherein the editing means performs editing including a process of adding a special effect to an image included in each of the contents.

10. The data processing device according to claim 1, wherein the control data receiving means receives the control data from an external recording medium or a network.

11. The data processing device according to claim 1, wherein:
one of the plurality of contents is a telop; and
the editing means performs editing including a process of superimposing the telop on an image included in another one of the plurality of contents.

12. The data processing device according to claim 1, wherein the editing means edits sound included in the plurality of contents.

13. A data processing method for a data processing device that processes content, comprising the steps of:
receiving a plurality of contents, and receiving control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and
generating the edited content, by editing the plurality of contents in accordance with the process parameter and the timing parameter included in the control data.

14. A program for causing a computer to function as a data processing device that processes content, the program causing the computer to function as:
content receiving means for receiving a plurality of contents;
control data receiving means for receiving control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and
editing means for generating the edited content, by editing the plurality of contents in accordance with the process parameter and the timing parameter included in the control data.

15. A data processing device that performs a process of editing a plurality of contents, comprising:
generating means for generating a process parameter set for each of the plurality of contents to process each of the contents, and a timing parameter indicating an output timing at which each of the contents is outputted as edited content that is content that has undergone editing;
editing means for generating the edited content, by editing the plurality of contents in accordance with the process parameter and the timing parameter; and
output means for outputting control data that includes the process parameter and the timing parameter, and is used for editing the plurality of contents to generate the edited content.

16. The data processing device according to claim 15, further comprising transmitting means for transmitting the plurality of contents and the control data.

17. The data processing device according to claim 16, wherein the generating means generates the process parameter that differs for each of the plurality of contents, in response to an editing operation made by a user for instructing editing.

18. The data processing device according to claim 17, wherein the editing means performs editing including a process of adjusting an image quality of an image included in each of the contents.

19. The data processing device according to claim 17, wherein the editing means performs editing including a process of improving a resolution of an image included in each of the contents.

20. The data processing device according to claim 17, wherein the editing means performs editing including a process of changing a size of an image included in each of the contents.

21. The data processing device according to claim 17, wherein the editing means performs editing including a process of extracting an area to be outputted as the edited content, from an image included in each of the contents.

22. The data processing device according to claim 17, wherein the editing means performs editing including a process of adding a special effect to an image included in each of the contents.

23. The data processing device according to claim 16, wherein:
one of the plurality of contents is a telop; and
the editing means performs editing including a process of superimposing the telop on an image included in another one of the plurality of contents.

24. The data processing device according to claim 16, wherein the editing means edits sound included in the plurality of contents.

25. A data processing method for a data processing device that performs a process of editing a plurality of contents, comprising the steps of:
generating a process parameter set for each of the plurality of contents to process each of the contents, and a timing parameter indicating an output timing at which each of the contents is outputted as edited content that is content that has undergone editing;
generating the edited content, by editing the plurality of contents in accordance with the process parameter and the timing parameter; and
outputting control data that includes the process parameter and the timing parameter, and is used for editing the plurality of contents to generate the edited content.

26. A program for causing a computer to function as a data processing device that performs a process of editing a plurality of contents, the program causing the computer to function as:
generating means for generating a process parameter set for each of the plurality of contents to process each of the contents, and a timing parameter indicating an output timing at which each of the contents is outputted as edited content that is content that has undergone editing;
editing means for generating the edited content, by editing the plurality of contents in accordance with the process parameter and the timing parameter; and
output means for outputting control data that includes the process parameter and the timing parameter, and is used for editing the plurality of contents to generate the edited content.

27. A data processing device that processes content, comprising:
a content receiving unit configured to receive a plurality of contents;
a control data receiving unit configured to receive control data including a process parameter set for each of the plurality of contents to process each of the contents, and a timing parameter indicating an output timing at which each of the contents is outputted as edited content that is content that has undergone editing, the control data being used for editing the plurality of contents to generate the edited content; and
an editing unit configured to generate the edited content, by editing the plurality of contents in accordance with the process parameter and the timing parameter included in the control data.

28. A data processing device that performs a process of editing a plurality of contents, comprising:
a generating unit configured to generate a process parameter set for each of the plurality of contents to process each of the contents, and a timing parameter indicating an output timing at which each of the contents is outputted as edited content that is content that has undergone editing;
an editing unit configured to generate the edited content, by editing the plurality of contents in accordance with the process parameter and the timing parameter; and
an output unit configured to output control data that includes the process parameter and the timing parameter, and is used for editing the plurality of contents to generate the edited content.
